(19) United States
(12) Patent Application Publication
(10) Pub. No.: US 2011/0039982 A1
(43) Pub. Date: Feb. 17, 2011

(54) EPOXY RESINS AND PROCESSES FOR PREPARING THE SAME

(76) Inventors: Robert E. Hefner, JR., Lake Jackson, TX (US); John W. Hull, JR., Midland, MI (US); James W. Ringer, Midland, MI (US); John N. Argyropoulos, Midland, MI (US)

Correspondence Address: The Dow Chemical Company, P.O. BOX 1967, 2040 Dow Center, Midland, MI, 48641, US

(21) Appl. No.: 12/989,656

(22) PCT Filed: May 4, 2009
(86) PCT No.: PCT/US09/42646

§ 371 Date: Oct. 26, 2010

Related U.S. Application Data
(60) Provisional application No. 61/055,236, filed on May 22, 2008.

(51) Int. Cl. C08L 63/00; C08G 59/02

(52) U.S. Cl. 523/400; 528/418; 528/408; 525/523

(57) ABSTRACT

Epoxy resins comprising a cis, trans-1,3- and -1,4-cyclohexanedimethylether moiety and processes for preparing the epoxy resins. The process of preparation of the epoxy resins comprises reacting (a) a mixture of a cis-1,3-cyclohexanedimethanol, a trans-1,3-cyclohexanedimethanol, a cis-1,4-cyclohexanedimethanol, and a trans-1,4-cyclohexanedimethanol, (b) an epihalohydrin, (c) a basic acting substance, (d) optionally, a solvent, (e) optionally, a catalyst, and/or (f) optionally, a dehydrating agent. The process may be a slurry epoxidation process, an anhydrous epoxidation process, or a Lewis acid catalyzed coupling and epoxidation process.

### BACKGROUND OF THE INVENTION

1. Field of the Invention

The present invention relates to epoxy resins comprising a cis, trans-1,3- and -1,4-cyclohexanedimethylether moiety and various processes for preparing the epoxy resins.

2. Description of Background and Related Art

It is known in art to use 1,3-cyclohexanedimethanol and 1,4-cyclohexanedimethanol to prepare polyesters. For example, U.S. Pat. No. 4,578,453 discloses the use of 1,3-cyclohexanedimethanol, 1,4-cyclohexanedimethanol or mixtures thereof to prepare polyesters. U.S. Pat. No. 6,806,314 discloses that a coating composition comprises polyester using 1,3-cyclohexanedimethanol and 1,4-cyclohexanedimethanol. U.S. Pat. No. 6,818,293 teaches the use of 1,3-cyclohexanedimethanol and 1,4-cyclohexanedimethanol for preparation of polyester fibers and films.

In addition, an epoxy resin comprising a diglycidyl ether of cis, trans-1,4-cyclohexanedimethanol alone is also known in the art. For example, U.S. Pat. No. 4,623,701 discloses a synthesis of an epoxy resin comprising a diglycidyl ether of 1,4-cyclohexanedimethanol from 1,4-cyclohexanedimethanol.

However, there is no disclosure nor suggestion in the prior art that teaches the use of a mixture of 1,3-cyclohexanedimethanol and 1,4-cyclohexanedimethanol to prepare epoxy resins. There is also no disclosure nor suggestion in the prior art that teaches epoxy resins comprising a cis, trans-1,3- and -1,4-cyclohexanedimethylether moiety, more specifically, epoxy resins comprising diglycidyl ethers of cis, trans-1,3- and -1,4-cyclohexanedimethanol.

While the epoxy resin comprising the diglycidyl ethers of cis, trans 1,4-cyclohexanedimethanol disclosed in U.S. Pat. No. 4,623,701 is useful for many applications, such as electrical laminates, coatings, castings, adhesives and the like, high viscosity and preferential crystallization of the trans isomer from the diglycidyl ethers of cis, trans-1,4-cyclohexanedimethanol at room temperature makes it difficult to store, transfer, and formulate the epoxy resin.

Therefore, what is needed in the industry is epoxy resins that have improved properties including no crystallization at room temperature and lower viscosity in order to increase the ability of the epoxy resins to accept higher solid contents than the epoxy resin comprising the diglycidyl ethers of cis, trans-1,4-cyclohexanedimethanol alone. It is also desired to provide epoxy resins which have a low total chloride (including ionic, hydrolyzable and total chloride) content and a higher diglycidyl ether content in order to increase the reactivity of the epoxy resins toward conventional epoxy resin curing agents, reduce the potential corrosivity of the epoxy resin, and improve the electrical properties of the epoxy resins.

### SUMMARY OF THE INVENTION

One aspect of the present invention is directed to an epoxy resin comprising a cis, trans-1,3- and -1,4-cyclohexanedimethylether moiety.

According to a preferred embodiment of the present invention, the epoxy resin comprises a diglycidyl ether of cis-1,3-cyclohexanedimethanol, a diglycidyl ether of trans-1,3-cyclohexanedimethanol, a diglycidyl ether of cis-1,4-cyclohexanedimethanol, and a diglycidyl ether of trans-1,4-cyclohexanedimethanol.

According to another preferred embodiment of the present invention, the epoxy resin comprises a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, and one or more oligomers thereof.

According to yet another preferred embodiment of the present invention, the epoxy resin comprises a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, a monoglycidyl ether of cis-1,3-cyclohexanedimethanol, a monoglycidyl ether of trans-1,3-cyclohexanedimethanol, a monoglycidyl ether of cis-1,4-cyclohexanedimethanol, and a monoglycidyl ether of trans-1,4-cyclohexanedimethanol.

According to another preferred embodiment of the present invention, the epoxy resin comprises a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, a monoglycidyl ether of cis-1,3-cyclohexanedimethanol, a monoglycidyl ether of trans-1,3-cyclohexanedimethanol, a monoglycidyl ether of cis-1,4-cyclohexanedimethanol, a monoglycidyl ether of trans-1,4-cyclohexanedimethanol, and one or more oligomers thereof.

Another aspect of the present invention is directed to a process of preparation of an epoxy resin, which comprises reacting (a) a mixture of a cis-1,3-cyclohexanedimethanol, a trans-1,3-cyclohexanedimethanol, a cis-1,4-cyclohexanedimethanol, and a trans-1,4-cyclohexanedimethanol (also referred to herein as “a cis, trans-1,3- and 1,4-cyclohexanedimethanol” or “the mixture (a)”) with (b) an epihalohydrin and (c) a basic acting substance. The process may optionally comprise (d) a solvent (e) a catalyst and/or (f) a dehydrating agent.

Preferably, the process of preparation of the epoxy resins of the present invention may be a slurry epoxidation process, an anhydrous epoxidation process, or a Lewis acid catalyzed coupling and epoxidation process.

The slurry epoxidation process comprises reacting (a) a cis, trans-1,3- and 1,4-cyclohexanedimethanol with (b) an epihalohydrin, and (c) a basic acting substance in an solid form or in an aqueous solution. The slurry epoxidation process may optionally comprise (d) a non-aqueous solvent, (e) a catalyst, and/or (f) a dehydrating agent.

The anhydrous epoxidation process comprises reacting (a) a cis, trans-1,3- and 1,4-cyclohexanedimethanol, (b) an epihalohydrin, and (c) a basic acting substance in an aqueous solution. The anhydrous epoxidation process may optionally comprise (d) a solvent, and/or (e) a catalyst.

The Lewis acid catalyzed coupling and epoxidation process comprises (1) reacting, in a coupling reaction, (a) a cis, trans-1,3- and 1,4-cyclohexanedimethanol and (b) an epihalohydrin in the presence of (c) a Lewis acid catalyst to form an intermediate product; (2) reacting the intermediate product, in a dehydrohalogenation reaction, with (d) a basic acting substance in an aqueous solution. The Lewis acid catalyzed coupling and epoxidation process may optionally comprise a solvent and/or a catalyst other than the Lewis acid catalyst.

Another aspect of the present invention is directed to a curable epoxy resin composition comprising a blend of (a) an epoxy resin, (b) at least one curing agent, and/or (c) at least one curing catalyst, wherein the epoxy resin comprises a cis, trans-1,3- and -1,4-cyclohexanedimethylether moiety.

Yet another aspect of the present invention is directed to a process comprising curing the above curable epoxy resin composition.

Another aspect of the present invention is directed to a cured epoxy resin prepared by the above process of curing the curable epoxy resin composition.

A further aspect of the present invention is directed to an article comprising an epoxy resin, wherein the epoxy resin comprises a cis, trans-1,3- and -1,4-cyclohexanedimethylether moiety.

The epoxy resins of the present invention, which comprise a cis, trans-1,3- and -1,4-cyclohexanedimethylether moiety, are found to have improved properties including no crystallization at room temperature and lower viscosity. These improved properties increase the ability of the epoxy resins to accept higher solid contents than the epoxy resin comprising the diglycidyl ethers of cis, trans-1,4-cyclohexanedimethanol alone. In addition, some epoxy resins of the present invention also have a very low total chloride (including ionic, hydrolyzable and total chloride) content and, as a result, the epoxy resins comprise a higher diglycidyl ether content, which increases the reactivity of the epoxy resins toward conventional epoxy resin curing agents, reduces the potential corrosivity of the epoxy resin, and improves the electrical properties of the epoxy resins.

### DETAILED DESCRIPTION OF THE INVENTION

In the following detailed description, specific embodiments of the present invention are described in connection with its preferred embodiments. However, to the extent that the following description is specific to a particular embodiment or a particular use of the present techniques, it is intended to be illustrative only and merely provides a concise description of the exemplary embodiments. Accordingly, the present invention is not limited to the specific embodiments described below, but rather; the present invention includes all alternatives, modifications, and equivalents falling within the true scope of the appended claims.

Unless otherwise stated, a reference to a material, a compound, or a component includes the material, compound, or component by itself, as well as in combination with other materials, compounds, or components, such as mixtures or combinations of compounds.

As used herein, the singular forms “a,” “an,” and “the” include the plural reference unless the context clearly dictates otherwise.

As noted above, the epoxy resins of the present invention comprise a cis, trans-1,3- and -1,4-cyclohexanedimethylether moiety. As used herein, the term “cis, trans-1,3- and -1,4-cyclohexanedimethylether moiety” means a structure or a blend of chemical structures comprising four geometric isomers, a cis-1,3-cyclohexanedimethylether, a trans-1,3-cyclohexanedimethylether structure, a cis-1,4-cyclohexanedimethylether, and a trans-1,4-cyclohexanedimethylether, within an epoxy resin. The four geometric isomers are shown in the followings structures:

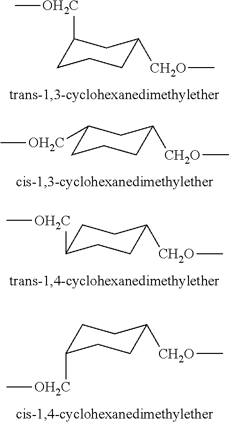

Preferably, the epoxy resin of the present invention comprises one of the following epoxy resins:

(1) an epoxy resin comprising a diglycidyl ether of cis-1,3-cyclohexanedimethanol, a diglycidyl ether of trans-1,3-cyclohexanedimethanol, a diglycidyl ether of cis-1,4-cyclohexanedimethanol, and a diglycidyl ether of trans-1,4-cyclohexanedimethanol (also referred to herein as “the diglycidyl ethers of cis, trans-1,3- and 1,4-cyclohexanedimethanol”);

(2) an epoxy resin comprising a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, and one or more oligomers thereof;

(3) an epoxy resin comprising a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, a monoglycidyl ether of cis-1,3-cyclohexanedimethanol, a monoglycidyl ether of trans-1,3-cyclohexanedimethanol, a monoglycidyl ether of cis-1,4-cyclohexanedimethanol, and a monoglycidyl ether of trans-1,4-cyclohexanedimethanol; or

(4) an epoxy resin comprising a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, a monoglycidyl ether of cis-1,3-cyclohexanedimethanol, a monoglycidyl ether of trans-1,3-cyclohexanedimethanol, a monoglycidyl ether of cis-1,4-cyclohexanedimethanol, a monoglycidyl ether of trans-1,4-cyclohexanedimethanol, and one or more oligomers thereof.

The epoxy resins (3) and (4) above may comprise a controlled amount of the monoglycidyl ether of cis-1,3-cyclohexanedimethanol, monoglycidyl ether of trans-1,3-cyclohexanedimethanol, monoglycidyl ether of cis-1,4-cyclohexanedimethanol, and monoglycidyl ether of trans-1,4-cyclohexanedimethanol (also referred to herein as “the monodiglycidyl ethers of cis, trans-1,3- and 1,4-cyclohexanedimethanol”). For example, the amount of the monoglycidyl ethers may be in the range of from about 0.1 percent to about 90 percent by weight; preferably, from about 0.1 percent to about 20 percent by weight; and more preferably, from about 0.1 percent to about 10 percent by weight based on the total weight of the epoxy resin.

In general, the epoxy resin of the present invention is prepared by a process (e.g. an epoxidation reaction process) comprising reacting (a) a mixture of a cis-1,3-cyclohexanedimethanol, a trans-1,3-cyclohexanedimethanol, a cis-1,4-cyclohexanedimethanol, and a trans-1,4-cyclohexanedimethanol (also referred to herein as “the cis-1,3- and 1,4-cyclohexanedimethanol” or “the mixture (a)”) with (b) an epihalohydrin, and (c) a basic acting substance. The process may also optionally comprise one or more of the following components: (d) a solvent, (e) a catalyst, and/or (f) a dehydrating agent.

In one embodiment, the process for preparing the epoxy resin of the present invention involves an initial reaction of the cis, trans-1,3- and 1,4-cyclohexanedimethanol with the epihalohydrin to form a halohydrin intermediate. The halohydrin intermediate formed in the initial reaction is then reacted with the basic acting substance to convert the halohydrin intermediate to the epoxy resin final product.

In another embodiment, an alkali metal or alkaline earth metal hydroxide may be used as a catalyst; and if such a catalyst is employed in stoichiometric or greater quantities, the initial reaction of the cis, trans-1,3- and 1,4-cyclohexanedimethanol and the epihalohydrin produces a halohydrin intermediate in situ. The halohydrin intermediate produced in situ may then be converted to the epoxy resin final product without the addition of the basic acting substance.

The cis, trans-1,3- and 1,4-cyclohexanedimethanol used in the present invention may be a cycloaliphatic diol. One of the commercially available cycloaliphatic diols useful in the present invention is a cis, trans-1,3- and 1,4-cyclohexanedimethanol mixture known as UNOXOL™ Diol, produced and marketed by The Dow Chemical Company. The UNOXOL™ Diol is an approximate 1:1 mixture of cis, trans-1,3- and 1,4-cyclohexanedimethanol and is a non-crystallizing liquid at room temperature.

Various amount of the cis, trans-1,3-cyclohexanedimethanol relative to the cis, trans-1,4-cyclohexanedimethanol may be present in the mixture to influence both the properties of the cis, trans-1,3- and 1,4-cyclohexanedimethanol as well as the ultimate properties of the epoxy resin final product. For example, if the mixture has higher cis, trans-1,3-cyclohexanedimethanol content, the reactant comprising the mixture is generally in liquid form and has lower viscosity than the reactant comprising the mixture with higher cis, trans-1,4-cyclohexanedimethanol content. Also, the reactant comprising the mixture with higher cis, trans-1,3-cyclohexanedimethanol content generally favors the production of epoxy resin with lower viscosity.

In general, the cis, trans-1,3- and -1,4-cyclohexanedimethanol (mixture (a)) used to prepare the epoxy resins of the present invention comprises a controlled amount of the cis, trans-1,3-cyclohexanedimethanol, for example, from about 1 percent to about 99 percent, preferably from about 15 percent to about 85 percent, and more preferably from about 40 percent to about 60 percent by weight of the cis, trans-1,3-cyclohexanedimethanol based on the total weight of the cis, trans-1,3- and -1,4-cyclohexanedimethanol.

Various amounts of the individual geometrical isomers may also be present in the mixture to influence both the properties of the cis, trans-1,3- and 1,4-cyclohexanedimethanol and the ultimate properties of the epoxy resin products formed from the reaction. For example, if the mixture has higher cis-isomer(s) content, the reactant comprising the mixture is generally in liquid form and has lower viscosity than the reactant comprising the mixture with higher trans-isomer(s) content. Also the reactant comprising the mixture with higher cis-isomer(s) content generally favors the production of epoxy resin with lower viscosity.

In general, the amount of each of the four isomers in the cis, trans-1,3- and 1,4-cyclohexanedimethanol varies between about 5 percent to about 95 percent by weight based on the total weight of the cis, trans-1,3- and -1,4-cyclohexanedimethanol.

Examples of the epihalohydrin used to prepare the epoxy resins of the present invention described herein include, for example, epichlorohydrin, epibromohydrin, epiiodohydrin, methylepichlorohydrin, methylepibromohydrin, methylepiiodohydrin, and any combination thereof. Epichlorohydrin is the preferred epihalohydrin used in some embodiments of the present invention.

The ratio of the epihalohydrin to the cis, trans-1,3- and 1,4-cyclohexanedimethanol mixture (a) is generally from about 1:1 to about 25:1, preferably from about 1.8:1 to about 10:1, and more preferably from about 2:1 to about 5:1 equivalents of epihalohydrin per primary hydroxyl group in the cis, trans-1,3- and 1,4-cyclohexanedimethanol.

In one embodiment the epihalohydrin comprises a mole ratio of from about 2:1 to about 5:1 moles of equivalents of epihalohydrin per primary hydroxyl group in the mixture (a); and in another embodiment, the epihalohydrin comprises a mole ratio of from about 2:1 to about 3:1 moles of equivalents of epihalohydrin per primary hydroxyl group in the mixture (a).

The term “primary hydroxyl group” used herein refers to the primary hydroxyl group or primary hydroxyl groups derived from the cis, trans-1,3- and 1,4-cyclohexanedimethanol. The primary hydroxyl group differs from a secondary hydroxyl group such as those formed during the process of the forming the halohydrin intermediate.

An alkali metal hydride may also be added to the cis, trans-1,3- and 1,4-cyclohexanedimethanol mixture to react with the cis, trans-1,3- and 1,4-cyclohexanedimethanol first and followed by reacting the resultant alkoxide with the epihalohydrin. Examples of the alkali metal hydride which may be used include sodium hydride, potassium hydride, and any mixture thereof or the like, with sodium hydride being the preferred alkali metal hydride.

A basic acting substance may be employed in the present invention to react with the aforementioned halohydrin intermediate to form the epoxy resin final product of the present invention disclosed herein. Examples of suitable basic acting substances include alkali metal hydroxides, alkaline earth metal hydroxides, carbonates, bicarbonates, and any mixture thereof, and the like.

More specific examples of the basic acting substance include sodium hydroxide, potassium hydroxide, lithium hydroxide, calcium hydroxide, barium hydroxide, magnesium hydroxide, manganese hydroxide, sodium carbonate, potassium carbonate, lithium carbonate, calcium carbonate, barium carbonate, magnesium carbonate, manganese carbonate, sodium bicarbonate, potassium bicarbonate, magnesium bicarbonate, lithium bicarbonate, calcium bicarbonate, barium bicarbonate, manganese bicarbonate, and any combination thereof. Sodium hydroxide and/or potassium hydroxide are the preferred basic acting substance.

According to the present invention, the epihalohydrin may function as both a solvent and a reactant. Alternatively, a solvent other than the epihalohydrin may also be used in the process for preparing the epoxy resins of the present invention. The solvent other than the epihalohydrin used should be inert to any materials used in the process of preparing the epoxy resins of the present invention, including for example, reactants, catalysts, intermediate products formed during the process, and final products.

Examples of the solvent which can be employed in the present invention include aliphatic and aromatic hydrocarbons, halogenated aliphatic hydrocarbons, aliphatic ethers, aliphatic nitriles, cyclic ethers, ketones, amides, sulfoxides, and any combination thereof.

Particularly preferred solvents include pentane, hexane, octane, toluene, xylene, methylethylketone, methylisobutylketone, N,N-dimethylformamide, dimethylsulfoxide, diethyl ether, tetrahydrofuran, 1,4-dioxane, dichloromethane, chloroform, ethylene dichloride, methyl chloroform, ethylene glycol dimethyl ether, N,N-dimethylacetamide, acetonitrile, and any combination thereof.

If the solvent other than the epihalohydrin is employed in the process of the present invention, the minimum amount of solvent needed to achieve the desired result is preferred. In general, the solvent may be present in the process from about 250 percent to about 1 percent by weight, preferably, about 50 percent to about 1 percent by weight, and more preferably, about 20 percent to about 5 percent by weight based on the total weight of the cis, trans-1,3- and 1,4-cyclohexanedimethanol. The solvent may be removed from the final product at the completion of the reaction of forming the epoxy resins of the present invention using conventional methods, such as vacuum distillation.

A catalyst may also be optionally employed to prepare the epoxy resins of the present invention. Examples of the catalyst include quaternary ammonium or phosphonium halides. More specific examples of the catalyst include benzyltrimethylammonium chloride, benzyltrimethylammonium bromide, tetrabutylammonium chloride, tetrabutylammonium bromide, tetraoctylammonium chloride, tetrabutylammonium bromide, tetramethylammonium chloride, tetramethylammonium bromide, tetrabutylphosphonium chloride, tetrabutylphosphonium bromide, tetrabutylphosphonium iodide, ethyltriphenylphosphonium chloride, ethyltriphenylphosphonium bromide, ethyltriphenylphosphonium iodide, and any combination thereof.

While the amount of catalyst may vary due to factors such as reaction time and reaction temperature, the lowest amount of catalyst required to produce the desired effect is preferred. In general, the catalyst may be used in an amount of from about 0.01 percent to about 3 percent by weight, preferably, from about 0.05 percent to about 2.5 percent by weight, and more preferably, from about 0.1 percent to about 1 percent by weight based on the total weight of the cis, trans-1,3- and 1,4-cyclohexanedimethanol.

A dehydrating agent may also be optionally employed to prepare the epoxy resins of the present invention. The dehydrating agent may be added before, after or concurrent with the basic acting substance.

Examples of the dehydrating agent include alkali metal sulfates, alkaline earth metal sulfates, molecular sieves, and any combination thereof. More specific examples of the dehydrating agent include sodium sulfate, potassium sulfate, lithium sulfate, calcium sulfate, barium sulfate, magnesium sulfate, manganese sulfate, molecular sieves, and any combination thereof.

The amount of dehydrating agent used may vary depending upon water contents present in the reactants including in the epichlorohydrin, in the basic acting substance, in the cis, trans-1,3- and 1,4-cyclohexanedimethanol, and in the solvent, if used. In addition, during a dehydrohalogenation reaction of the halohydrin intermediate to form the epoxy resin final product, when an alkali metal hydroxide or alkaline earth metal hydroxide is used as the basic acting substance, water may be co-produced along with the epoxy resin final product and alkali halides. Thus, the amount of dehydrating agent may also need to be adjusted to consume a part or all of the water co-produced from the aforementioned dehydrohalogenation reaction.

Other minor components may be present or purposely added to the cis, trans-1,3- and 1,4-cyclohexanedimethanol. Examples of one or more minor components which may be present in the cis, trans-1,3- and 1,4-cyclohexanedimethanol include cis-1,2-cyclohexanedimethanol, trans-1,2-cyclohexanedimethanol, 2-hydroxy-3-oxabicyclo[3.3.1]nonane, 3-oxabicyclo[3.3.1]nona-2-one, and dimerization products thereof.

Examples of the one or more minor components which may be purposely added to the cis, trans-1,3- and 1,4-cyclohexanedimethanol include aliphatic diols or polyols and cycloaliphatic diols other than the cis, trans-1,3- and 1,4-cyclohexanedimethanol.

More specific examples of the minor components include ethylene glycol, diethylene glycol, poly(ethylene glycol)s, neopentyl glycol, 1,4-butanediol, trimethylolpropanes, cyclohexane diols, norbornane dimethanols, and dicyclopentadiene dimethanols, and any combination thereof. The diols or polyols may be epoxidized simultaneously during the epoxidation of the cis, trans-1,3- and 1,4-cyclohexanedimethanol. The resultant epoxy resin comprises a mixture of the epoxy resin produced from the cis, trans-1,3- and 1,4-cyclohexanedimethanol and the epoxy resin produced from the respective aliphatic diols, aliphatic polyol, or cycloaliphatic diol other than the cis, trans-1,3- and 1,4-cyclohexanedimethanol. In this manner, a specific mixture of epoxy resins may be obtained without mixing of epoxy resins from separate sources. This may be done to obtain specific properties, such as, for example, a reduction in viscosity relative to the viscosity of the epoxy resin of cis, trans-1,3- and 1,4-cyclohexanedimethanol.

The amounts and types of the minor components may vary depending on the specific chemistry of the components and the process used to prepare the cis, trans-1,3- and 1,4-cyclohexanedimethanol. In general, the minor components may comprise less than about 50 percent, preferably, from about 0.01 percent to about 25 percent, and more preferably, from about 0.001 percent to about 10 percent minor components based on the total weight of the cis, trans-1,3- and 1,4-cyclohexanedimethanol.

The process for preparing the epoxy resins comprising the cis, trans-1,3- and -1,4-cyclohexanedimethylether moiety of the present invention may be carried out under various process conditions. For example, the temperature used in the process for preparing the epoxy resins is generally from about 20° C. to about 120° C., preferably from about 30° C. to about 85° C., and more preferably from about 40° C. to about 75° C.

The pressure used in the process for preparing the epoxy resins is generally from about 30 mm Hg vacuum to about 100 psia, preferably from about 30 mm Hg vacuum to about 50 psia, and more preferably from about 60 mm Hg vacuum to about atmospheric pressure (e.g. 760 mm Hg).

The time for completion of the process for preparing the epoxy resins is generally from about 1 hour to about 120 hours, more preferably from about 3 hours to about 72 hours, and most preferably from about 4 hours to about 48 hours.

Various analytical methods (for example, gas chromatography (GC), high performance liquid chromatography (HPLC), and gel permeation chromatographic (GPC) may be used to determine the progress or completion of the process. The exact analytical method selected depends on the structure of the reactants and the epoxy resin products. For example, gas chromatography may be employed to monitor reaction of the cis, trans-1,3- and 1,4-cyclohexanedimethanol concurrently with the formation of intermediate products and final products (e.g. the diglycidyl ethers of cis, trans-1,3- and 1,4-cyclohexanedimethanol, the monoglycidyl ethers of cis, trans-1,3- and 1,4-cyclohexanedimethanol, and oligomers thereof which are volatile under the conditions used for the GC analysis). GPC analysis may also be employed to analyze the oligomers which are not volatile and generally not detected by the GC analysis. By using the analytical methods to monitor the epoxidation process, various components of the epoxy resins of the present invention may be determined, and by adjusting the epoxidation process conditions based on the various components found in the epoxy resin, various epoxy resin products may be obtained.

For example, a shorter reaction time and/or a lower reaction temperature generally leads to the formation of epoxy resins comprising a greater amount of the monoglycidyl ethers of cis, trans-1,3- and 1,4-cyclohexanedimethanol accompanied by a lesser amount of the oligomer of such epoxy resins. Conversely, a longer reaction time and/or a higher reaction temperature generally leads to the formation of epoxy resins comprising a lesser amount of the monoglycidyl ethers of cis, trans-1,3- and 1,4-cyclohexanedimethanol accompanied by a greater amount of the oligomer of such epoxy resins. Accordingly, the combination of reaction time and reaction temperature may be adjusted to provide the desired epoxy resins of the present invention.

According to a various embodiments of the present invention, the epoxy resins of the present invention may be prepared by various processes including, for example, (1) a slurry epoxidation process, (2) an anhydrous epoxidation process, or (3) a combination Lewis acid catalyzed coupling reaction and a slurry epoxidation reaction process.

The slurry epoxidation process useful in the present invention comprises reacting (a) a cis, trans-1,3- and 1,4-cyclohexanedimethanol, as described above, with (b) an epihalohydrin, and (c) a basic acting substance in a solid form or in an aqueous solution (water). The slurry epoxidation process may optionally comprise any one or more of the following components: (d) a solvent or a mixture of solvents other than water, (e) a catalyst, and/or (f) a dehydrating agent. Examples of the epihalohydrin, the basic acting substance, the solvent, the catalyst, and the dehydrating agent for use in the slurry epoxidation process are described above.

In the slurry epoxidation process, when the basic acting substance is present in a solid form, it is usually in the form of a pellet, a bead, or a powder. Various particle sizes or particle size distributions of the basic acting substance may be employed. For example, the basic acting substance, such as solid sodium hydroxide, having a particle size distribution of from about −40 to about +60 mesh, or from about −60 to about +80 mesh may be employed in the present invention. In another embodiment, the particle size distribution employed may be for example about −80 mesh.

In the slurry epoxidation process, when the basic acting substance is present in an aqueous solution (water), the aqueous solution (water) may be removed by a distillation such as an azeotropic distillation, a co-distillation, or a flash distillation. The distillation may be conducted under vacuum.

According to the present invention, the azeotropic distillation may comprise (1) adding the basic acting substance in the aqueous solution (water) to the solvent other than water to form a solvent-water azeotrope and (2) distilling the solvent-water azeotrope to remove the aqueous solution (water) from the basic acting substance. The co-distillation may comprise (1) adding the basic acting substance in the aqueous solution (water) to the solvent other than water to form a water solvent co-distillate and (2) distilling the water solvent co-distillate to remove the aqueous solution (water) from the basic acting substance. It may also be possible to simply flash distill water from the aqueous solution of the basic acting substance (e.g. heating the basic acting substance to vaporize off the water) to leave the dry basic acting substance behind as a solid.

The term “azeotrope” is referred to as a mixture of liquids (e.g. mixture of solvent and water) that has a constant boiling point because the vapor form of the mixture has the same composition as the liquid form of the mixture. The components of the mixture usually cannot be separated by simple distillation.

The term “azeotropic distillation” refers to a process for separating, by distillation, a product which is not easily separable otherwise. The essential characteristic of the azeotropic distillation process is an introduction of another component which forms an azeotropic mixture with an initial component in the product and the initial component is then partially or totally distilled off to obtain a pure product.

The term “codistillate” refers to a mixture of liquids wherein water codistills with one or more solvents. The codistillate does not have a constant boiling point like the azeotrope. The term “codistillation” refers to a distillation performed on a mixture of liquids where water codistills with one or more solvents.

In one embodiment of the present invention, the aqueous solution (water) of basic acting substance may be first added to the solvent (or solvents) other than water to form a solvent-water azeotrope or a co-distillable mixture of a solvent (or solvents) and water. The aqueous solution (water) in the basic acting substance can then be removed via the distillation of the solvent-water azeotrope or codistillation of the mixture of the solvent (or solvents) and water. Both the azeotropic distillation and codistillation may be performed under vacuum. The solvent present in the solvent-water azeotrope or the co-distillable mixture can be any solvent which is inert to the slurry epoxidation process of preparing the epoxy resins of the present invention including inert to the reactants, the catalysts, any intermediate products formed during the slurry epoxidation process, and the final products. Examples of the solvents useful in the process include the same solvents as those described above.

The distillation may be performed continuously until the desired basic acting substance is produced either as a neat solid (dry) or as a solvent slurry (with residual solvent). If residual solvent is left behind to form the solvent slurry of the basic acting substance, the solvent used should be inert to the subsequent slurry epoxidation reaction including any reactants, intermediate products, and final products. Examples of such solvents include toluene and xylene.

In a preferred example of the slurry epoxidation process, the slurry epoxidation process involves adding the cis, trans-1,3- and 1,4-cyclohexanedimethanol to a stirred slurry of sodium hydroxide in epichlorohydrin. The sodium hydroxide may be in the form of a solid such as pellets, beads or powder or a mixture thereof. The solid sodium hydroxide may also be essentially anhydrous to slightly damp. The term “essentially anhydrous” or “slightly damp” as used herein means that the solid sodium hydroxide comprises less than about 5 percent by weight of water based on the total weight of the solid sodium hydroxide.

In general, the solid sodium hydroxide comprises less than about 5 percent, preferably less than about 4 percent, and more preferably less than about 2.5 percent by weight of water based on the total weight of the solid sodium hydroxide.

In another preferred example of the slurry epoxidation process, the slurry epoxidation process involves adding the cis, trans-1,3- and 1,4-cyclohexanedimethanol to a stirred slurry of sodium hydroxide and anhydrous sodium sulfate in epichlorohydrin. Both the sodium hydroxide and sodium sulfate may be in the form of a solid such as pellets, beads, powder, or granular. The solid sodium hydroxide may also be essentially anhydrous or slightly damp. The anhydrous sodium sulfate is preferred to be in the granular form.

According to the present invention, it is desired to produce an epoxy resin product comprising the highest possible amount of the diglycidyl ethers of cis, trans-1,3- and 1,4-cyclohexanedimethanol. However, it has been discovered that, during the slurry epoxidation process, as the reaction reaches about 95 weight percent or higher conversion of the cis, trans-1,3- and 1,4-cyclohexanedimethanol to the epoxy resin product, the viscosity of the reaction slurry increases sufficiently to cause significant reduction in mixing and effective heat transfer out of the reaction slurry. The increased viscosity may slow down or discontinue the reaction. Furthermore, under these conditions, a substantial amount of cis, trans-1,3- and 1,4-cyclohexanedimethanol monoglycidyl ether may still be present. In order to reduce viscosity, concomitantly restore heat transfer, and thus continue the reaction, a further addition (also referred to as “back-addition”) of epichlorohydrin may be needed. The epichlorohydrin may be back-added in an additional amount of from about 0.25 to about 2 equivalents, preferably, from about 0.25 to about 1 equivalents, and more preferably from about 0.25 to about 0.50 equivalent of epichlorohydrin per primary hydroxyl originally present in the cis, trans-1,3- and 1,4-cyclohexanedimethanol.

In the slurry epoxidation process, it is within the scope of the present invention to add a greater amount of epichlorohydrin at the inception of the reaction for eventual viscosity control. Generally, an additional amount of from about 0.50 to about 2 equivalents, preferably, from about 0.50 to about 1.5 equivalents, and more preferably from about 0.50 to about 1.0 equivalents of epichlorohydrin per primary hydroxyl originally present in the cis, trans-1,3- and 1,4-cyclohexanedimethanol may be added at the inception of the reaction. However, it has been discovered in the present invention that, during the slurry epoxidation process, increasing epichlorohydrin stoichiometry above about 2 to about 3 equivalents of epichlorohydrin per primary hydroxyl in the mixture at the inception of the reaction may lead to additional formation of 2-epoxypropyl ether, an unwanted side-product. The formation of the 2-epoxypropyl ether consumes valuable epihalohydrin as well as the basic acting substance such as sodium hydroxide. The 2-epoxypropyl ether side-product may be removed from the product by vacuum distillation.

The epoxy resins of the present invention may also be prepared by an anhydrous epoxidation process. The anhydrous epoxidation process comprises reacting (a) a mixture of a cis-1,3-cyclohexanedimethanol, a trans-1,3-cyclohexanedimethanol, a cis-1,4-cyclohexanedimethanol, and a trans-1,4-cyclohexanedimethanol, (b) an epihalohydrin, and (c) a basic acting substance in an aqueous solution. The anhydrous epoxidation process may optionally comprise any one or more of the following components: (d) a solvent, and/or (e) a catalyst. Examples of the epihalohydrin, the basic acting substance, the solvent, and the catalyst suitable to be used in the anhydrous epoxidation process are described above.

In the anhydrous epoxidation process, a basic acting substance in an aqueous solution may be employed. The aqueous solution (water) may be removed by a distillation such as an azeotropic distillation, a co-distillation, or a flash distillation. The distillation may be conducted under vacuum.

According to the present invention, the azeotropic distillation may comprise (1) adding the epihalohydrin to the basic acting substance in the aqueous solution (water) to form a binary epihalohydrin-water azeotrope or adding the epihalohydrin to the basic acting substance in the aqueous solution (water) and the solvent to form a ternary epihalohydrin-water-solvent azeotrope, and (2) distilling the binary epihalohydrin-water azeotrope or the ternary epihalohydrin-water-solvent azeotrope to remove the aqueous solution (water) from the basic acting substance. The co-distillation may comprise (1) adding the basic acting substance in the aqueous solution (water) to the solvent to form a water solvent co-distillate and (2) distilling the water solvent co-distillate to remove the aqueous solution (water) from the basic acting substance. It may also be possible to simply flash distill water from the aqueous solution of the basic acting substance (e.g. heating the basic acting substance to vaporize off the water) to leave the dry basic acting substance behind as a solid.

Additional details concerning the removal of water via distillation during epoxidation processes may be found in U.S. Pat. No. 4,499,255, which is incorporated herein by reference.

In one embodiment of the anhydrous epoxidation process, the anhydrous epoxidation process involves controlled addition of the sodium hydroxide as an aqueous solution to a stirred mixture of the cis, trans-1,3- and 1,4-cyclohexanedimethanol, and epichlorohydrin with continuous vacuum distillation of an epichlorohydrin-water azeotrope, removing of the water fraction from the distilled azeotrope, and recycling of the recovered epichlorohydrin back into the reaction. A catalyst may also be added to the stirred mixture. A quaternary ammonium halide catalyst is particularly preferred.

It is impractical to use a high concentration of sodium hydroxide in the aqueous solution due to very high viscosity and partial crystallization of the sodium hydroxide. An aqueous solution comprising about 50 percent by weight of sodium hydroxide is particularly preferred. More diluted aqueous sodium hydroxide, while operable, is less preferred due to the additional time and energy expended to remove the additional water and additional waste generated.

The epoxy resins of the present invention may also be prepared by a combination of a Lewis acid catalyzed coupling reaction and a slurry epoxidation reaction process (herein “the Lewis acid coupling/epoxidation process”). The Lewis acid coupling/epoxidation process comprises reacting, in a first coupling reaction step: (a) the cis, trans-1,3- and 1,4-cyclohexanedimethanol described above, with (b) an epihalohydrin in the presence of (c) a Lewis acid catalyst. The coupling reaction step of the Lewis acid coupling/epoxidation process produces an intermediate product comprising a halohydrin. The intermediate halohydrin product is then subjected to a dehydrohalogenation reaction step of the Lewis acid coupling/epoxidation process. The dehydrohalogenation reaction comprises reacting the intermediate halohydrin product with (d) a basic acting substance in an aqueous solution to form an epoxy resin product. The Lewis acid coupling/epoxidation process may optionally comprise any one or more of the following components: (e) a solvent and/or (f) a catalyst other than the Lewis acid catalyst. Examples of the epihalohydrin, the basic acting substance, the solvent, and the catalyst other than the Lewis acid catalyst suitable to be used in the Lewis acid coupling/epoxidation process are described above.

Examples of the Lewis acid used in the Lewis acid coupling/epoxidation process include boron trifluoride or a boron trifluoride complex, such as boron trifluoride etherate, tin (IV) chloride, aluminum chloride, ferric chloride, zinc chloride, silicon tetrachloride, titanium tetrachloride, antimony trichloride, and any mixtures thereof.

The amount of the Lewis acid employed in the present invention may be from about 0.00015 to about 0.015, preferably from about 0.00075 to about 0.0075, and more preferably from about 0.0009 to about 0.005 moles per mole of the mixture of the cis, trans-1,3 and 1,4-cyclohexanedimethanol. The amount of the Lewis acid used may also depend on particular reaction variables such as reaction time and reaction temperature.

In one embodiment of the Lewis acid coupling/epoxidation process, the coupling reaction step of the Lewis acid coupling/epoxidation process involves adding an epichlorohydrin to a stirred mixture or solution of the cis, trans-1,3- and 1,4-cyclohexanedimethanol and the Lewis acid catalyst to produce an intermediate product comprising a halohydrin such as a chlorohydrin. Tin (IV) tetrachloride is particularly preferred as the Lewis acid catalyst. Once the coupling reaction is complete, the intermediate product is diluted with water and methylisobutylketone. The diluted intermediate product is then reacted in a dehydrohalogenation reaction step of the Lewis acid coupling/epoxidation process with sodium hydroxide in an aqueous solution.

It is impractical to use a high concentration of sodium hydroxide in the aqueous solution due to very high viscosity and partial crystallization of the sodium hydroxide. An aqueous solution comprising about 50 percent by weight of sodium hydroxide is particularly preferred. The use of a more diluted aqueous sodium hydroxide, while operable, is less preferred due to the additional time and energy expended to remove the additional water and additional waste generated.

A catalyst other than the Lewis acid catalyst may also be employed in any of the aforementioned epoxidation processes to prepare the epoxy resins of the present invention. If used, the non-Lewis acid catalyst may be added at any time during the slurry epoxidation or anhydrous epoxidation processes. In the Lewis acid coupling/epoxidation process, the non-Lewis acid catalyst, if used, is preferably added only to the dehydrohalogenation reaction step of the Lewis acid coupling/epoxidation process.

The slurry epoxidation or anhydrous epoxidation processes of the present invention may also be conducted with epihalohydrin, such as epichlorohydrin, being used as both a solvent and a reactant. For example, the slurry epoxidation process may be conducted by reacting the cis, trans-1,3- and 1,4-cyclohexanedimethanol with the epihalohydrin in a ratio of about 2 to about 3 equivalents of epihalohydrin per primary hydroxyl in the mixture. This slurry epoxidation process provides an easily mixed reaction slurry because the initial viscosity of the reaction slurry is low and the heat generated from the slurry epoxidation process, including the heat from the reaction and heat from the stirring of the reaction mixture, can be easily transferred out of the reactor.

Any of the processes for preparing an epoxy resin of the present invention may also include a recovery and purification process. The recovery and purification can be performed using methods such as gravity filtration, vacuum filtration, vacuum distillation including rotary evaporation and fractional vacuum distillation, centrifugation, water washing or extraction, solvent extraction, decantation, column chromatography, vacuum distillation, falling film distillation, wiped film distillation, electrostatic coalescence, and other known recovery and purification processing methods and the like. Fractional vacuum distillation is a preferred method for the recovery and purification process of high purity (e.g. greater than about 99%) epoxy resin of the present invention that is substantially free of oligomer).

The term “free of oligomer” or “substantially free of oligomer” used herein means that the oligomer is present in the epoxy resin in a concentration of less than about 2 percent, preferably less than about 1 percent, and more preferably zero percent by weight based on the total weight of the epoxy resin final product.

The recovery and purification process comprises removing and recovering fractions (e.g. components, also referred to as “cuts” in the following Examples) with lower boiling points, including those components with boiling points below that of the cis, trans-1,3- and 1,4-cyclohexanedimethanol. Examples of these fractions include unreacted epihalohydrin and co-produced 2-epoxypropyl ether. The recovered epihalohydrin can be recycled (e.g. re-used as a reactant) and the 2-epoxypropyl ether can be used for other purposes, such as a reactive intermediate product. Any unreacted cis, trans-1,3- and 1,4-cyclohexanedimethanol may also be recovered via a fractional distillation process for recycle. The remaining portion in a distillation pot of the fractional distillation process after removal of the aforementioned fractions generally comprises a concentrated source of oligomer which may be used as an epoxy resin product itself or may be used as a component to be blended, in a controlled amount, with the epoxy resins of the present invention.

According to a preferred embodiment of the present invention, the fractions or components including those with boiling points below the cis, trans-1,3- and 1,4-cyclohexanedimethanol and any unreacted cis, trans-1,3- and 1,4-cyclohexanedimethanol are removed via vacuum distillation until the total amounts of the components with boiling points below the cis, trans-1,3- and 1,4-cyclohexanedimethanol is less than about 1 percent by weight based on the total weight of the epoxy resin final product. Some of or all of the monoglycidyl ethers of the cis, trans-1,3- and 1,4-cyclohexanedimethanol may also be removed via vacuum distillation.

When none or a controlled amount of the monoglycidyl ethers of the cis, trans-1,3- and 1,4-cyclohexanedimethanol are removed via vacuum distillation, the process of the present invention produces an epoxy resin final product comprising the diglycidyl ethers of trans, cis-1,3- and -1,4-cyclohexanedimethanol, the monoglycidyl ethers of trans, cis-1,3- and -1,4-cyclohexanedimethanol, and one or more oligomers thereof.

When all of the monoglycidyl ethers of the cis, trans-1,3- and 1,4-cyclohexanedimethanol are removed via vacuum distillation, the process of the present invention produces an epoxy resin final product comprising diglycidyl ethers of trans, cis-1,3- and -1,4-cyclohexanedimethanol, and one or more oligomers thereof.

In one embodiment of the present invention, during the recovery and purification process, the epoxy resin produced from the slurry epoxidation reaction can be centrifuged and/or filtered to remove solid salts (e.g. unreacted sodium hydroxide and sodium chloride if epichlorohydrin is used). Components in the epoxy resin including those with boiling points below the cis, trans-1,3- and 1,4-cyclohexanedimethanol and any unreacted cis, trans-1,3- and 1,4-cyclohexanedimethanol are removed via vacuum distillation to provide the epoxy resin final product of the present invention. This recovery and purification process is essentially a non-aqueous process, which has advantages over other recovery and purification processes using an aqueous solution (an aqueous process). For example, in a non-aqueous process, the waste salt solids generated from the non-aqueous process can be easily recovered and disposed. In an aqueous process, however, the waste generated from the aqueous process is an aqueous liquid, which is more difficult to handle and dispose compared to the solid waste generated from the non-aqueous process.

The epoxy resins of the present invention are non-crystallizing at room temperature (e.g. about 25° C.) and have the ability to accept high solid contents due to the presence of both cis- and trans-isomers in the epoxy resins and low viscosity. Additionally, the epoxy resins of the present invention, produced by the slurry epoxidation process, or the anhydrous epoxidation process, possess very low chloride (including ionic, hydrolyzable and total chloride) contents. The epoxy resins of the present invention with low chloride content have advantages over the epoxy resins comprising diglycidyl ethers of cis, trans 1,4-cyclohexanedimethanol alone including the following: (a) the reactivity of the epoxy resins of the present invention when cured with conventional epoxy resin curing agents is improved, (b) the diglycidyl ether contents of the epoxy resins of the present invention is increased, (c) the potential corrosivity of the epoxy resins of the present invention is reduced, and (d) the electrical properties of the epoxy resins of the present invention is improved. The epoxy resins produced by the Lewis acid catalyzed coupling and epoxidation process may be slightly higher in total chloride content (e.g. chloromethyl groups bound into the epoxy resin structures) compared to the slurry epoxidation process and the anhydrous epoxidation process, however, the Lewis acid catalyzed coupling and epoxidation process is a relatively simple process and the epoxy resins produced by the Lewis acid catalyzed coupling and epoxidation process have very low viscosity.

The epoxy resins of the present invention may be used alone or cured with curing agents and/or catalysts to produce various cured epoxy resins.

The cured epoxy resins may be prepared by curing a curable epoxy resin composition comprising the epoxy resin of the present invention, a curing agent, and/or a catalyst.

The process of curing the curable epoxy resin composition may be conducted at atmospheric, superatmospheric or subatmospheric pressures and at temperatures of from about 0° C. to about 300° C., preferably from about 25° C. to about 250° C., and more preferably from about 50° C. to about 200° C.

The time required to complete the process of curing the curable epoxy resin composition depends upon the temperature employed. Higher temperature requires shorter curing time whereas lower temperatures require longer curing time. Generally, the curing process may be completed in about 1 minute to about 48 hours, preferably from about 15 minutes to about 24 hours, and more preferably from about 30 minutes to about 12 hours.

It is also operable to partially cure the curable epoxy resin composition of the present invention to form a B-stage product and subsequently cure the B-stage product completely at a later time.

The curing agent and/or catalyst useful for curing the curable epoxy resins composition of the present invention may be any curing agents and/or catalysts known for curing epoxy resin.

Examples of the curing agent include aliphatic, cycloaliphatic, polycycloaliphatic or aromatic primary monoamines; aliphatic, cycloaliphatic, polycycloaliphatic or aromatic primary and secondary polyamines; carboxylic acids and anhydrides thereof; aromatic hydroxyl containing compounds; imidazoles; guanidines; urea-aldehyde resins; melamine-aldehyde resins; alkoxylated urea-aldehyde resins; alkoxylated melamine-aldehyde resins; amidoamines; epoxy resin adducts; and any combinations thereof.

Particularly suitable curing agents include, for example, methylenedianiline; 4,4′-diaminostilbene; 4,4′-diamino-alpha-methylstilbene; 4,4′-diaminobenzanilide; dicyandiamide; ethylenediamine; diethylenetriamine; triethylenetetramine; tetraethylenepentamine; urea-formaldehyde resins; melamine-formaldehyde resins; methylolated urea-formaldehyde resins; methylolated melamine-formaldehyde resins; phenol-formaldehyde novolac resins, cresol-formaldehyde novolac resins, sulfanilamide, diaminodiphenylsulfone, diethyltoluenediamine; t-butyltoluenediamine; bis-4-aminocyclohexylamine; isophoronediamine; diaminocyclohexane; hexamethylenediamine; piperazine; aminoethylpiperazine; 2,5-dimethyl-2,5-hexanediamine; 1,12-dodecanediamine; tris-3-aminopropylamine; and any combinations thereof.

Examples of suitable curing catalysts include boron trifluoride, boron trifluoride etherate, aluminum chloride, ferric chloride, zinc chloride, silicon tetrachloride, stannic chloride, titanium tetrachloride, antimony trichloride, boron trifluoride monoethanolamine complex, boron trifluoride triethanolamine complex, boron trifluoride piperidine complex, pyridine-borane complex, diethanolamine borate, zinc fluoroborate, metallic acylates such as stannous octoate or zinc octoate, and any mixtures thereof.

The curing agent useful for curing the curable epoxy resin composition may comprise at least two reactive hydrogen atoms per molecule. The curing agent may be employed in an amount which will effectively cure the epoxy resin of the present invention. In general, a suitable amount of curing agent that my be used in the present invention may range from about 0.80:1 to about 1.50:1, and preferably from about 0.95:1 to about 1.05:1 equivalents of reactive hydrogen atom in the curing agent per equivalent of epoxide group in the epoxy resin of the present invention. The “reactive hydrogen atom” is the hydrogen atom present in the curing agent which is reactive with an epoxide group in the epoxy resin of the present invention.

Similarly, the curing catalyst is also employed in an amount which will effectively cure the epoxy resin of the present invention. Generally, a suitable amount of the curing catalyst that may be employed in the present invention may be from about 0.0001 percent to about 2 percent, and preferably from about 0.01 percent to about 0.5 percent by weight based on the total weight of the epoxy resin of the present invention.

One or more of the curing catalysts may be employed in the process of curing the curable epoxy resin composition in order to accelerate or otherwise modify the curing process.

Other optional additives may also be present in the curable epoxy resin composition in addition to the curing agent and/or catalyst. The additives may include, for example, a cure accelerator, a solvent, a diluent (including non-reactive diluents, monoepoxide diluents, epoxy resin diluents other than those comprising a cis, trans-1,3- and -1,4-cyclohexanedimethylether moiety, and reactive non-epoxide diluents), a modifier such as a flow modifier or a thickener, a reinforcing material, a filler, a pigment, a dye, a mold release agent, a wetting agent, a stabilizer, a fire retardant agent, a surfactant, or any combination thereof.

These additives may be added to the curable epoxy resin composition in functionally equivalent amounts, for example, the pigment and/or dye may be added in quantities which will provide the composition with the desired color. In general, the amount of the additives used in the present invention may be from about zero to about 20 percent, preferably from about 0.5 percent to about 5 percent, and more preferably from about 0.5 percent to about 3 percent by weight based upon the total weight of the curable epoxy resin composition.

The cure accelerator which may be used herein includes, for example, mono, di, tri and tetraphenols; chlorinated phenols; aliphatic or cycloaliphatic mono or dicarboxylic acids; aromatic carboxylic acids; hydroxybenzoic acids; halogenated salicylic acids; boric acid; aromatic sulfonic acids; imidazoles; tertiary amines; aminoalcohols; aminopyridines; aminophenols, mercaptophenols; and any mixture thereof.

Particularly suitable cure accelerators include 2,4-dimethylphenol, 2,6-dimethylphenol, 4-methylphenol, 4-tertiary-butylphenol, 2-chlorophenol, 4-chlorophenol, 2,4-dichlorophenol, 4-nitrophenol, 1,2-dihydroxybenzene, 1,3-dihydroxybenzene, 2,2′-dihydroxybiphenyl, 4,4′-isopropylidenediphenol, valeric acid, oxalic acid, benzoic acid, 2,4-dichlorobenzoic acid, 5-chlorosalicylic acid, salicylic acid, p-toluenesulfonic acid, benzenesulfonic acid, hydroxybenzoic acid, 4-ethyl-2-methylimidazole, 1-methylimidazole, triethylamine, tributylamine, N,N-diethylethanolamine, N,N-dimethylbenzylamine, 2,4,6-tris(dimethylamino)phenol, 4-dimethylaminopyridine, 4-aminophenol, 2-aminophenol, 4-mercaptophenol, or any combination thereof.

Examples of the solvent which may be used herein include, for example, aliphatic and aromatic hydrocarbons, halogenated aliphatic hydrocarbons, aliphatic ethers, aliphatic nitriles, cyclic ethers, glycol ethers, esters, ketones, amides, sulfoxides, and any combination thereof.

Particularly suitable solvents include pentane, hexane, octane, toluene, xylene, methylethylketone, methylisobutylketone, N,N-dimethylformamide, dimethylsulfoxide, diethyl ether, tetrahydrofuran, 1,4-dioxane, dichloromethane, chloroform, ethylene dichloride, methyl chloroform, ethylene glycol dimethyl ether, diethylene glycol methyl ether, dipropylene glycol methyl ether, N-methylpyrrolidinone, N,N-dimethylacetamide, acetonitrile, sulfolane, and any combination thereof.

Examples of diluents which may be used herein include, for example, dibutyl phthalate, dioctyl phthalate, styrene, low molecular weight polystyrene, styrene oxide, allyl glycidyl ether, phenyl glycidyl ether, butyl glycidyl ether, vinylcyclohexene oxide, neopentylglycol diglycidyl ether, butanediol diglycidyl ether, hexanediol diglycidyl ether, diethylene glycol diglycidyl ether, dipropylene glycol diglycidyl ether, poly(propylene glycol) diglycidyl ether, thiodiglycol diglycidyl ether, maleic anhydride, ε-caprolactam, butyrolactone, acrylonitrile, and any combination thereof.

Particularly suitable diluents include, for example, the epoxy resin diluents such as neopentylglycol diglycidyl ether, butanediol diglycidyl ether, hexanediol diglycidyl ether, diethylene glycol diglycidyl ether, dipropylene glycol diglycidyl ether, poly(propylene glycol) diglycidyl ether, poly(ethylene glycol) diglycidyl ether, thiodiglycol diglycidyl ether, and any combination thereof.

The modifier, such as thickener and flow modifier, may be employed in amounts of from zero to about 10 percent, preferably, from about 0.5 percent to about 6 percent, and more preferably from about 0.5 percent to about 4 percent by weight based upon the total weight of the curable epoxy resin composition.

The reinforcing material which may be employed herein includes natural and synthetic fibers in the form of woven fabric, mat, monofilament, multifilament, unidirectional fiber, roving, random fiber or filament, inorganic filler or whisker, hollow sphere, and any combination thereof. Other suitable reinforcing material includes glass, carbon, ceramics, nylon, rayon, cotton, aramid, graphite, polyalkylene terephthalates, polyethylene, polypropylene, polyesters, and any combination thereof.

The filler which may be employed herein includes, for example, inorganic oxides, ceramic microsphere, plastic microsphere, glass microsphere, inorganic whisker, calcium carbonate, and any combination thereof.

The filler may be employed in an amount from about zero to about 95 percent, preferably from about 10 percent to about 80 percent, and more preferably from about 40 percent to about 60 percent by weight based upon the total weight of the curable epoxy resin composition.

The epoxy resins or the cured epoxy resins of the present invention are particularly useful in coatings, especially for protective coatings which provide solvent resistant, moisture resistant, abrasion resistant, and weatherable properties; electrical or structural laminates or composites; filament windings; moldings; castings; encapsulation; stabilizer additives for plastics; and the like.

### EXAMPLES

### Abbreviations

The following standard abbreviations are used in the Examples and Comparative Experiments:
GC=gas chromatography (chromatographic)
GPC=gel permeation chromatography (chromatographic)
EEW=epoxide equivalent weight
RSD=relative standard deviation
DI=deionized
eq=equivalent
wt=weight(s)
min=minute(s)
hr=hour(s)
g=gram(s)
mL=milliliter(s)
L=liter(s)
mm=millimeter(s)
M=meter(s)
cp=centipoise
CHDM=cis-, trans-1,3- and 1,4-cyclohexanedimethanol
CHDM MGE=monoglycidyl ether of cis, trans-1,3- and 1,4-cyclohexanedimethanol
CHDM DGE=diglycidyl ether of cis, trans-1,3- and 1,4-cyclohexanedimethanol
epi=epichlorohydrin
MIBK=methylisobutylketone (4-methyl-2-pentanone)

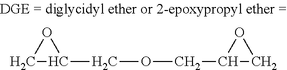

The CHDM used in the following Examples and Comparative Experiments was a commercial grade product UNOXOL™ Diol (manufactured and marketed by The Dow Chemical Company). GC analysis of the CHDM revealed the presence of 99.5 area % (22.3 area %, 32.3 area %, 19.6 area %, and 25.3 area % for 4 individual isomers) with the 0.5 area % balance comprising a single minor impurity.

Analytical Equipment and Methods

The following standard analytical equipment and methods are used in the Examples and Comparative Experiments:

Gas Chromatographic (GC) Analysis

A Hewlett Packard 5890 Series II Plus gas chromatograph was employed using a DB-1 capillary column (61.4 M by 0.25 mm, Agilent). The column was maintained in the chromatograph oven at a 50° C. initial temperature. Both the injector inlet and flame ionization detector were maintained at 300° C. Helium carrier gas flow through the column was maintained at 1.1 mL per min. The temperature program employed a 2 min hold time at 50° C., a heating rate of 10° C. per min to a final temperature of 300° C., and a hold time at 300° C. of 15 min. When a sample was analyzed with oligomers that did not elute from the column, the chromatograph oven was held at 300° C. prior to analysis of the next sample until the residual oligomers had “burned off”. All components with retention times greater than that of the 4 isomeric CHDM diglycidyl ethers were designated as oligomers in the following Examples and Comparative Experiments. All GC analyses in the following Examples and Comparative Experiments are measured in area %, and as such are not a quantitative measure of any given component.

Samples for GC analysis were prepared by collection of a 0.5 mL aliquot of an epoxy resin product from the epoxidation process and addition to a vial comprising 1 mL of acetonitrile. A portion of the product in acetonitrile was mixed then loaded into a 1 mL syringe (Norm-Ject, all polypropylene/polyethylene, Henke Sass Wolf GmBH) and passed through a syringe filter (Acrodisc CR 13 with 0.2 μm PTFE membrane, Pall Corporation, Gelman Laboratories) to remove any inorganic salts or debris.

I.C.I. Cone and Plate Viscosity

Viscosity was determined on an I.C.I. Cone and Plate Viscometer (model VR-4540) at 25° C. The viscometer equipped with a 0-5 poise spindle (model VR-4105) and equilibrated to 25° C. was calibrated to zero. A sample was applied to the viscometer and held for 2 min, then the viscosity was checked and the reading was taken after 15 seconds. One or more duplicate viscosity tests were completed using a fresh aliquot of the particular product being tested. The individual measurements were averaged.

Gel Permeation Chromatographic (GPC) Analysis

A PL-gel Mixed E pair of columns maintained at 40° C. were used in series along with a differential refractometer detector (Waters 410). Tetrahydrofuran was used as an eluent at a flow rate of 1 mL per min. The injection volume was 100 microliters. A sample was diluted in tetrahydrofuran to a concentration of 0.45-0.50%. Calibration was performed using Polymer Laboratories Polyethylene Glycol Calibrants, PEG 10, Lot 16. RSD for Mₙ, M_{w}, M_{w}/Mₙ, Mₚ and M_{z} was less than 3% and for M_{z+1} RSD was less than 6%, with the exception of Examples 9-11 where RSD for Mₙ, M_{w}, M_{w}/Mₙ, Mₚ and M_{z} was less than 4% and for M_{z+1} RSD was less than 8%. The chromatogram was visually examined and different peak windows were selected for individual integration of the respective peaks. Precision was determined by analyzing the sample in duplicate. The RSD's for Mₚ (the molecular weight at the apex of the peak) and area % are less than 1% for peak windows greater than 10% of the total area and less than 10% for peak windows less than 10% of the total area. The area percent and peak molecular weights thus obtained were averaged to give the indicated results in the following Examples and Comparative Experiments.

Hydrolyzable, Ionic and Total Chloride Analysis

Hydrolyzable chloride generally results from a coupling product (e.g. chlorohydrin intermediate) which has not cyclized via dehydrochlorination with sodium hydroxide to give the epoxide ring during the epoxidation process.

Ionic chloride includes sodium chloride co-product from the epoxidation process which has been entrained in the epoxy resin product. Sodium chloride is co-produced in the dehydrochlorination of a chlorohydrin with sodium hydroxide.

Total chloride accounts for the chlorine bound into the epoxy resin structure in the form of a chloromethyl group. The chloromethyl group forms as a result of a coupling reaction of a secondary hydroxyl group in a chlorohydrin intermediate with epi.

The ionic and hydrolyzable and total chlorides were determined using titration methods while the total chloride was determined via X-ray fluorescence analysis.

Water Analysis in Sodium Hydroxide and Epi

For water analyses of various batches of sodium hydroxide, approximately 1.0 g portions of sodium hydroxide powder were added to 3 separate vials which had previously been tared on scales inside of a glovebox. Each vial was capped with a septum and then crimped shut with the exact weight of the sodium hydroxide powder in each sealed vial ascertained. A series of 3 empty glass vials were additionally capped with septa and then crimped shut for use as standards. All six sealed vials were removed from the glovebox and analyzed for water with a Brinkmann Karl Fischer 756 Coulometer with a 774 oven sample processor that was equipped with a diaphragmless electrode system and Hydranal Coulomat AG titrant. For the analysis, each vial was introduced into the oven maintained at 120° C. where water vapor was driven off and swept into a titration vessel by a nitrogen stream. The 3 empty glass vials provided the background correction for the water absorbed on to the glass surface. A 0.1% Hydranal water standard was also analyzed and yielded 91% recovery. Water analyses of epi used a Brinkmann Karl Fischer 756 Coulometer equipped with a diaphragmless electrode system and Hydranal Coulomat AG titrant (buffered with 20 g imidazole per 100 mL of titrant). A 0.1% Hydranal water standard was also analyzed and yielded 105% recovery.

Percent Epoxide/Epoxide Equivalent Weight (EEW) Analysis

A standard titration method was used to determine percent epoxide in the various epoxy resins. A sample was weighed (ranging from about 0.1 to about 0.2 g) and dissolved in dichloromethane (15 mL). Tetraethylammonium bromide solution in acetic acid (15 mL) was added to the sample. The resultant solution was treated with 3 drops of crystal violet solution (0.1% w/v in acetic acid) and was titrated with 0.1N perchloric acid in acetic acid on a Metrohm 665 Dosimat titrator (Brinkmann). Titration of a blank sample comprising dichloromethane (15 mL) and tetraethylammonium bromide solution in acetic acid (15 mL) provided correction for solvent background. General methods for this titration are found in scientific literature, for example, Jay, R. R., “Direct Titration of Epoxy Compounds and Aziridines”, Analytical Chemistry, 36, 3, 667-668 (March, 1964).

The following Examples and Comparative Experiments further illustrate the present invention in detail but are not to be construed to limit the scope thereof.

### Example 1

### Range Finding CHDM Epoxidation Reactions

A series of 6 range finding epoxidation reactions (Parts A-F shown in Table I) were completed in 1 L glassware using 0.5 mole (1.0 —OH eq.) CHDM, epi, and solid NaOH (20-40 mesh beads) as reactants. Unless otherwise specified, the mole ratio of isomeric cyclohexanedimethanol:epi:NaOH was 0.5:2:3 (eq ratio of 1:2:3). The CHDM reactant was added as indicated to a stirred slurry of NaOH in epi. Reaction times given in Table I commence with the first addition of the CHDM. Table I summarizes the results from these epoxidation reactions plus salient observations.

TABLE I

| | CHDM | | | | | | | |
|---|---|---|---|---|---|---|---|---|
| Example 1 | Addition | | Reaction | Analysis (GC area %)^{1a} | | | | |
| (Parts | Time | Reaction | Time | | CHDM | CHDM | | |
| A-F) | (min) | Conditions | (hr) | CHDM | MGE | DGE | Oligomers² | DGE |
| A | 47 | 40° C.^{3a,3c} | 48^{3b} | .7 | .8 | 2.8 | .0 | .6 |
| B | 67 | 70° C. to 75° C. | 1.18 | 1.6 | 6.7 | 4.9 | one | .2 |
| | | over 16 min, | 1.4^{4b} | 1.2 | 4.1 | 0.9 | .6 | .6 |
| | | at 71 min | 2.0^{4c} | .3 | 2.6 | 7.5 | .7 | .8 |
| | | cool stepwise | 5.0^{4d} | .13 | 0.0 | 9.1 | .9 | .6 |
| | | to 65° C. and | | | | | | |
| | | hold^{4a} | | | | | | |
| C | 215 | 75° C., | 5.4^{5a} | .20 | .1 | 9.9 | .5 | 4.7 |
| | | increased epi | 8.2^{5b} | .09^{5c} | .0 | 7.9 | .3 | 5.8 |
| | | to give a | | | | | | |
| | | 1:3:3 eq ratio | | | | | | |
| | | of | | | | | | |
| | | CHDM:epi:NaOH | | | | | | |
| D | 140 | 40° C., added | 94⁷ | .0 | .1 | 0.1 | .6 | .5 |
| | | anhydrous | | | | | | |
| | | toluene (200 mL) | | | | | | |
| | | initially⁶ | | | | | | |
| E | 160 | 40° C., added | 28^{8a} | .15 | .7 | 0.2 | .0 | .5 |
| | | anhydrous | 44.3^{8b} | .15 | .4 | 8.1 | .1 | .5 |
| | | Na₂SO₄ (0.5 | | | | | | |
| | | mole) | | | | | | |
| | | initially⁶ | | | | | | |
| F⁹ | 160 | 40° C.⁶ | 23 | .50 | .2 | 4.6 | .6 | .12 |
| | | | 68.3 | .14 | .7 | 1.3 | .2 | .3 |

Notes for Table I
^{1a}epi and any solvent peaks were normalized out of all GC data
²GC analysis does not include oligomers which are non-volatile under the conditions of the analysis
^{3a}exothermed to 46° C. at 52 min
^{3b}no further conversion of CHDM and CHDM MGE after 22 hr
^{3c}viscous slurry at 22 hr with poor mixing and heat transfer
^{4a}exothermed from 74° C. to 75.5° C. at 71 min (controlled by removal of heating mantle and cooling fan on the reactor exterior), stepwise cooling to 65° C. caused self-heating to cease
^{4b}viscous slurry at 1.4 hr
^{4c}high viscosity impeded mixing, added toluene (50 mL) immediately reducing viscosity and restoring mixing, at 3.0 hr high viscosity again impeded mixing, added additional toluene (50 mL) immediately reducing viscosity and restoring mixing,
^{4d}high viscosity again impeded mixing, terminated reaction
^{5a}high viscosity impeded mixing, added additional epi (100 mL) immediately reducing viscosity and restoring mixing
^{5b}high viscosity impeded mixing and heat transfer, reactor at 78° C. (3° C. above set point) and can no longer cool down, terminated reaction
^{5c}the CHDM value seems anomalously high based on the prior sample
⁶no exothermicity
⁷mixing ceased due to high viscosity, terminated reaction
^{8a}high viscosity impeded mixing, added toluene (100 mL) immediately reducing viscosity and restoring mixing
^{8b}acceptable mixing
⁹epoxidation completed for comparison with experiments (D) and (E)

### Example 2

### Preparation of CHDM MGE and CHDM DGE Free of Oligomeric Components by Vacuum Distillation

The reaction reported in Part C of Example 1 was terminated via dilution with toluene (200 mL) to facilitate removal of the product slurry from the reactor. The toluene slurry was removed from the reactor and diluted with additional toluene (1.5 L). The slurry was filtered through a pad diatomaceous earth supported on a 600 mL coarse fritted glass funnel. Periodically, salts collecting on top of the pad of diatomaceous earth were scraped off using a spatula to speed the vacuum filtration. The resultant filtrate was rotary evaporated using a maximum bath temperature of 100° C. to provide 145.04 g of light amber colored, transparent liquid. GC analysis revealed the presence of 0.8 area % residual epi, 4.3 area % residual toluene, 0.7 area % unreacted CHDM, 3.7 area % CHDM MGE (1.0, 0.5, 1.5, and 0.7 area % for the 4 individual isomers), 65.1 area % CHDM DGE (15.7, 20.9, 8.4, and 20.1 area % for the 4 individual isomers), 14.2 area % DGE, 5.0 area % oligomers (14 minor components), with the balance as several minor components.

The product from the rotary evaporation was added to a 500 mL, 3 neck, glass, round bottom, reactor equipped with magnetic stirring, a thermometer for monitoring the pot temperature, a short path distillation head (2.5 inch length of open glass tube with a 1 inch inside diameter) with overhead thermometer, air cooled condenser, a receiver and a vacuum takeoff. A vacuum pump capable of achieving less than 1 mm Hg was employed. Stirring commenced followed by application of full vacuum then progressively increased heating using a thermostatically controlled heating mantle. A clean receiver was used to collect each respective distillation cut. The following distillation cuts were collected:

| Distillation | Pot Temperature | Overhead Temperature | Weight |
|---|---|---|---|
| Cut | (° C.) | (° C.) | (g) |
| 1 | 75-76 | 42-49 | 23.52 |
| 2 | 100-112 | 39-47 | 2.43 |
| 3 | 128-137 | 64-94 | 1.36 |
| 4 | 150-190 | 91-134 | 82.19 |
| Pot residue | — | — | 28.48 |
| Totals | — | — | 137.98^{a} |
| Recovery | — | — | 95.13% |

^{a}Does not include liquid which distilled into the vacuum pump trap

The residual product left in the pot at the end of the distillation comprised 28.48 g of viscous amber liquid. GC analysis substantiated that the oligomeric components remained in the pot and comprised 50.9 area % (17 components). The balance of the product was 1.4 area % CHDM MGE and 45.0 area % CHDM DGE, plus 2.7 area % as 4 minor impurities.

GC analysis of Cut 4 revealed that all components boiling below that of the CHDM had been removed. This was further substantiated by the GC analyses of Cuts 1, 2 and 3 showing the presence of these lower boiling components which were no longer present in Cut 4. Thus, the Cut 4 product contained 0.57 area % unreacted CHDM, 4.5 area % CHDM MGE (1.2 area %, 0.6 area %, 1.8 area %, and 0.9 area % for the 4 individual isomers), 91.2 area % CHDM DGE (22.3 area %, 29.4 area %, 11.7 area %, and 27.8 area % for the 4 individual isomers), with the balance as several minor components and no oligomeric components detected. Titration of an aliquot of the Cut 4 product demonstrated 31.92% epoxide (134.82 EEW). Viscosity of an aliquot of the Cut 4 product at 25° C. was determined on an I.C.I. Cone and Plate Viscometer. A duplicate viscosity test was completed using a fresh aliquot of the Cut 4 product. The two individual measurements gave viscosities of 32.5 cp and 35 cp for an average of 34 cp. During a year of observation at 22° C.-24° C., the Cut 4 product remained as a colorless, transparent liquid free of any crystallization.

### Example 3

### Preparation of High Purity (>99.5 area %) CHDM DGE (Free of Oligomeric Components) by Vacuum Distillation

The reaction reported in Part F of Example 1 was terminated via dilution with toluene (200 mL) to facilitate removal from the reactor. The toluene slurry was removed from the reactor and rotary evaporated using a maximum bath temperature of 100° C. to provide a tacky solid product. The product from the rotary evaporation was slurried with acetone (1 L) using vigorous mixing, and then allowed to settle for 1 hr. The cloudy liquid layer which formed on top of the solids which had settled out was decanted through a pad diatomaceous earth supported on a 600 mL coarse fritted glass funnel. Periodically, salts collecting on top of the pad of diatomaceous earth were scraped off using a spatula to speed the vacuum filtration. The filtrate was rotary evaporated to provide 108.9 g of light yellow colored, transparent liquid. The solids, including those removed from the diatomaceous earth on the filter, were slurried with fresh acetone (0.5 L), allowed to settle (26 min) and decanted through the diatomaceous earth pad on the coarse fritted glass funnel. Rotary evaporation of this additional filtrate gave a cumulative 153.9 g of light yellow colored, transparent liquid. A third repetition of slurrying with fresh acetone (0.5 L), settling (6 min) and decantation through the diatomaceous earth filter provided a cumulative 184.9 g of light yellow colored, transparent liquid after rotary evaporation. A fourth and final repetition of the aforementioned process yielded a cumulative 186.7 g of light yellow colored, transparent liquid. GC analysis revealed the presence of 44.2 area % residual toluene, 0.32 area % CHDM, 3.07 area % CHDM MGE (0.79 area %, 0.45 area %, 1.23 area %, and 0.60 area % for the 4 individual isomers), 49.8 area % CHDM DGE (12.6 area %, 18.0 area %, 5.6 area %, and 13.6 area % for the 4 individual isomers), 1.08 area % DGE, 1.0 area % oligomers (6 minor components), with the balance as several minor components.

The product from the rotary evaporation was added to a 250 mL, 3 neck, glass, round bottom, reactor pot equipped with magnetic stirring and a thermometer for monitoring the pot temperature. A one piece integral vacuum jacketed Vigreaux distillation column and head was attached to the reactor. The distillation column nominally provided 9 to 18 theoretical plates depending on the mode of operation. The distillation head was equipped with an overhead thermometer, air cooled condenser, a receiver and a vacuum takeoff. A vacuum pump was employed along with a liquid nitrogen trap and an in-line digital thermal conductivity vacuum gauge. Stirring commenced followed by application of full vacuum then progressively increased heating using a thermostatically controlled heating mantle. A clean receiver was used to collect each respective distillation cut. During the distillation, the 3 initial distillation cuts, Cuts 1 to 3, were collected to sequentially remove all components boiling below the CHDM, all CHDM, and the bulk of the CHDM MGE. For the final distillation cut, Cut 4, the first distillate was collected into the receiver at a pot temperature/overhead temperature/vacuum of 172° C./134° C./0.44 mm Hg. The maximum distillation temperatures reached a 182° C. pot temperature and a 148.5° C. overhead temperature under a vacuum of 0.42 mm Hg to 0.43 mm Hg. Distillation ceased at a pot temperature of 180° C., accompanied by an overhead temperature of 127° C. and a vacuum of 0.43 mm Hg. Total time to collect this distillation cut was 31 min. The transparent, clear, liquid product collected in the receiver comprised 41.2 g. GC analysis of Cut 4 revealed 0.14 area % CHDM MGE (0.04 area %, 0.02 area %, 0.05 area %, and 0.03 area % for the 4 individual isomers), 99.60 area % CHDM DGE (22.4 area %, 36.3 area %, 11.7 area %, and 29.2 area % for the 4 individual isomers), with the balance as 2 minor impurities (0.16 area % and 0.10 area %, respectively). Titration of an aliquot of the Cut 4 product demonstrated 33.43% epoxide (128.73 EEW). For 100% pure CHDM DGE, theoretical % epoxide and EEW were calculated to be 33.587% and 128.12, respectively. Viscosity of an aliquot of the Cut 4 product at 25° C. was determined on an I.C.I. Cone and Plate Viscometer. A duplicate viscosity test was completed using a fresh aliquot of the Cut 4 product. The 2 individual measurements each gave an average viscosity of 29 cp. A portion of the Cut 4 product obtained from the distillation was analyzed by GPC giving the following results: Mₙ=195, M_{w}=198, M_{w}/Mₙ=1.02, Mₚ=194, M_{z}=203, M_{z+1}=211. Integration of peak windows of the respective peaks gave the following results:

| Peak Window | Mₚ | Area % |
|---|---|---|
| A | 194 | 99.5 |
| B | 436 | 0.5 |

During a year of observation at 22-24° C., the Cut 4 product remained as a colorless, transparent liquid free of any crystallization.

### Example 4

### Preparation of CHDM MGE and CHDM DGE Mixtures Free of Unreacted CHDM (Free of Oligomeric Components) by Vacuum Distillation

The epoxidation of Example 1 was repeated with a three-fold increase in scale with respect to the CHDM reactant (216.32 g, 1.5 moles, 3.0 —OH eq) and a reaction temperature of 65° C. A fan used to cool the reactor exterior was cycled with heating provided by the heating mantle. The addition time for the CHDM aliquots was 4.3 hr. After 2.6 hr from completion of the addition of the CHDM, GC analysis of a sample of the slurry product (diluted into acetonitrile then filtered to remove inorganic solids, analysis normalized to remove acetonitrile and epi) revealed the presence of 0.16 area % unreacted CHDM, 5.1 area % CHDM MGE (1.6 area %, 1.0 area %, 1.6 area %, and 0.9 area % for the 4 individual isomers), 84.2 area % CHDM DGE (22.9 area %, 29.5 area %, 9.7 area %, and 22.1 area % for the 4 individual isomers), 5.8 area % DGE, 1.7 area % oligomers (8 minor components), with the balance as several minor components. At this time, the product slurry was so thick that mixing of the slurry was impaired and dissipation of heat from the reactor was poor, thus the reaction was terminated via dilution with toluene (300 mL) to facilitate removal of the slurry product from the reactor. The toluene slurry was removed from the reactor and processed as previously described, with the single exception that acetonitrile (4 L total) was used as the solvent to slurry the product. GC analysis revealed the presence of 0.39 area % unreacted CHDM, 5.3 area % CHDM MGE (1.6 area %, 1.0 area %, 1.8 area %, and 0.9 area % for the 4 individual isomers), 86.9 area % CHDM DGE (22.4 area %, 31.5 area %, 10.2 area %, and 22.8 area % for the 4 individual isomers), 4.2 area % DGE, 2.0 area % oligomers (14 minor components), with the balance as several minor components.

A. Composition Comprising 13.85 area % Monoglycidyl ethers

A portion (161.7 g) of the product from the rotary evaporation was vacuum distilled using the method of Example 3. Two initial distillation cuts, Cuts 1 and 2, were collected to sequentially remove all components boiling below the CHDM MGE (GC analysis of an aliquot of product from the distillation pot after these 2 cuts were distilled off revealed the presence of no CHDM or lower boiling components). For the third distillation cut (Cut 3), the first distillate collected into the receiver at a pot temperature/overhead temperature/vacuum of 172° C./120° C./0.84 mm Hg. The maximum distillation temperatures reached a 172° C. pot temperature and a 129° C. overhead temperature under a vacuum of 0.82 mm Hg to 0.84 mm Hg. Distillation of this cut was stopped at a pot temperature of 168° C., accompanied by an overhead temperature of 126° C. and a vacuum of 0.46 mm Hg. Total time to collect this distillation cut was 87 min. The transparent, clear, liquid product collected in the receiver comprised 18.7 g.

GC analysis of Cut 3 revealed 13.85 area % CHDM MGE (4.11 area %, 2.51 area %, 5.08 area %, and 2.15 area % for the 4 individual isomers), 83.29 area % CHDM DGE (25.57 area %, 29.95 area %, 9.45 area %, and 18.32 area % for the 4 individual isomers), with the balance comprising 2.86 area % of 11 minor impurities. Titration of an aliquot of the Cut 3 product demonstrated 31.66% epoxide (135.93 EEW). Viscosity of an aliquot of the Cut 3 product at 25° C. was determined on an I.C.I. Cone and Plate Viscometer. The 2 individual measurements gave viscosities of 35 cp and 37.5 cp for an average of 36 cp. During a year of observation at 22° C.-24° C., the Cut 3 product remained as a colorless, transparent liquid free of any crystallization.

B. Composition Comprising 2.69 area % Monoglycidyl ethers

The distillation described above was continued with collection of an additional mixture of CHDM MGE and CHDM DGE wherein the amount of the monoglycidyl ether was substantially reduced. Thus, for Cut 4, the first distillate was collected into the receiver at a pot temperature/overhead temperature/vacuum of 169° C./124° C./0.46 mm Hg. The maximum distillation temperatures reached a 172° C. pot temperature and 135° C. overhead temperature under a vacuum of 0.46 mm Hg. Distillation of this cut was stopped at a pot temperature of 168° C., accompanied by an overhead temperature of 131° C. and a vacuum of 0.42 mm Hg. Total time to collect this distillation cut was 8 min. The transparent, clear, liquid product collected in the receiver comprised 8.0 g.

GC analysis of Cut 4 revealed 2.69 area % CHDM MGE (0.78 area %, 0.45 area %, 1.01 area %, and 0.45 area % for the 4 individual components), 96.00 area % CHDM DGE (26.43 area %, 35.67 area %, 11.37 area %, and 22.53 area % for the 4 individual components), with the balance as 3 minor impurities (0.55 area %, 0.47 area %, and 0.29 area %, respectively). Titration of an aliquot of the Cut 4 product demonstrated 33.31% epoxide (129.17 EEW). Viscosity of an aliquot of the Cut 4 product at 25° C. was determined on an I.C.I. Cone and Plate Viscometer. The 2 individual measurements gave viscosities of 28.75 cp and 30 cp for an average of 29 cp. During a year of observation at 22° C.-24° C., the Cut 4 product remained as a colorless, transparent liquid free of any crystallization.

C. Analysis of Chlorides in a Distilled Product

Vacuum distillation was performed in the manner above. GC analysis of the distillation cut from the vacuum distillation revealed 0.49 area % CHDM MGE (0.15 area %, 0.09 area %, 0.17 area %, and 0.08 area %), 99.02 area % CHDM DGE (23.83 area %, 36.38 area %, 11.65 area %, and 27.16 area %), with the balance as 3 minor impurities (0.11 area %, 0.23 area %, and 0.15 area %, respectively). A portion of this distillation cut product was analyzed for ionic, hydrolyzable and total chlorides giving the following results: Hydrolyzable Cl=25.7 and 22.7 ppm for an average of 24.2 ppm, Ionic Cl=0.324 ppm, Total Cl=0.0240%.

### Example 5

### Process for Epi Addition During Postreaction for Viscosity Reduction

The epoxidation process was repeated using method of Part F of Example 1 with a three-fold increase in scale with respect to the CHDM reactant (216.32 g, 1.5 moles, 3.0 —OH eq). A fan used to cool the reactor exterior was cycled with heating provided by the heating mantle. The addition time for the CHDM aliquots was 3.4 hr. After 27 hr from completion of the addition of the CHDM, GC analysis of a sample of the slurry product (diluted into acetonitrile then filtered to remove inorganic solids, analysis normalized to remove acetonitrile and epi) revealed the presence of 0.42 area % unreacted CHDM, 7.4 area % CHDM MGE (2.5 area %, 1.5 area %, 2.2 area %, and 1.2 area % for the 4 individual isomers), 87.7 area % CHDM DGE (24.2 area %, 30.5 area %, 9.8 area %, and 23.2, area % for the 4 individual isomers), 1.5 area % DGE, 1.1 area % oligomers (5 minor components), with the balance as several minor components. At this time, the product slurry had thickened and additional epi (193 mL) was added to the slurry immediately producing a thin, easily mixed slurry. After a cumulative 43 hr from completion of the addition of the CHDM, the thick product slurry was diluted with dichloromethane (300 mL) to facilitate removal of the slurry product from the reactor. The crude CHDM MGE and CHDM DGE comprising oligomeric components was then isolated, as follows: The dichloromethane slurry was removed from the reactor and rotary evaporated using a maximum bath temperature of 70° C. to provide a tacky solid product (920.6 g). The product from the rotary evaporation was slurried with MIBK (1 L) using vigorous mixing, then allowed to settle for 12 hr. The clear liquid layer which formed on top of the solids which had settled out was decanted through a pad diatomaceous earth supported on a 600 mL coarse fritted glass funnel. The solids remaining after decantation were slurried with fresh MIBK (0.5 L), allowed to settle 1 hr and the clear liquid top layer decanted through the diatomaceous earth pad on the coarse fritted glass funnel. A third repetition of slurrying with fresh MIBK (0.5 L), settling (12 hr) and decantation of the clear liquid top layer through the diatomaceous earth filter provided a cumulative 225.8 g of light yellow colored, transparent liquid after rotary evaporation. In a fourth repetition of the aforementioned process, the entire slurry formed via the addition of MIBK (0.5 L) was filtered over the diatomaceous earth bed. Salts collecting on top of the pad of diatomaceous earth and occluding filtration were periodically scraped off using a spatula to speed the vacuum filtration. Rotary evaporation of the filtrate yielded a cumulative 261.4 g of light yellow colored, transparent liquid. The solids collected on the diatomaceous earth pad were removed and combined with fresh MIBK (0.5 L), then the resultant slurry filtered over the diatomaceous earth bed. Rotary evaporation of the filtrate yielded a cumulative 307.2 g of light yellow colored, transparent liquid. GC analysis revealed the presence of 1.8 area % residual MIBK, 1.3 area % CHDM, 4.6 area % CHDM MGE (1.2 area %, 0.6 area %, 1.9 area %, and 0.9 area % for the 4 individual isomers), 83.7 area % CHDM DGE (20.9 area %, 30.6 area %, 9.6 area %, and 22.6 area % for the 4 individual isomers), 4.0 area % DGE, 2.4 area % oligomers (19 minor components), with the balance as several minor components.

The product from the rotary evaporation was vacuum distilled using the equipment and method previously described in Example 3. The first distillate was collected into the receiver at a pot temperature/overhead temperature/vacuum of 106° C./57° C./0.85 mm Hg. The maximum distillation temperatures reached a 174° C. pot temperature and 142° C. overhead temperature under a vacuum of 0.61 mm Hg and the distillation was stopped at this time. Total time to collect this distillation cut was 94 min. The transparent, clear, liquid, product collected in the receiver comprised 41.6 g. The yellow colored product remaining in the pot comprised 257.8 g (for purposes of mass balance, the 7.8 g not accounted for from the original product charged to the distillation pot was found in the liquid nitrogen trap). GC analysis of the product from the distillation pot revealed 3.5 area % CHDM MGE (0.9 area %, 0.5 area %, 1.5 area %, and 0.6 area % for the 4 individual isomers), 90.2 area % CHDM DGE (22.2 area %, 33.1 area %, 10.4 area %, and 24.5 area % for the 4 individual isomers), 5.4 area % oligomers (>22 minor components), with the balance as several minor impurities. Titration of an aliquot of the product obtained from the distillation pot demonstrated 30.41% epoxide (141.52 EEW). Viscosity of an aliquot of the product from the distillation pot at 25° C. was determined on an I.C.I. Cone and Plate Viscometer. The 2 individual measurements gave viscosities of 77.5 cp and 75 cp for an average of 76 cp. During a year of observation at 22° C.-24° C., the product remained as a colorless, transparent liquid free of any crystallization. A portion of the product from the distillation pot was analyzed for ionic, hydrolyzable and total chlorides giving the following results: Hydrolyzable Cl=83 ppm, Ionic Cl=8.156 ppm, Total Cl=0.2304%. A portion of the product obtained from the distillation pot was analyzed by GPC giving the following results: Mₙ=239, M_{w}=335, M_{w}/Mₙ=1.41, Mₚ=195, M_{z}=708, M_{z+1}=2010. Integration of peak windows of the respective peaks gave the following results:

| Peak Window | Mₚ | Area % |
|---|---|---|
| A | 195 | 71.1 |
| B | 326 | 3.5 |
| C | 446 | 13.8 |
| D | 651 | 4.8 |
| E | 830 | 2.4 |
| F | 1000-6500 MW tail | 4.7 |

### Example 6

### Isolation of Reaction Product from the Epoxidation of CHDM Using an Aqueous Process

The epoxidation process of CHDM was repeated using the method of Example 5 with the single exception that dilution with dichloromethane to facilitate removal of the product slurry from the reactor at the end of the reaction was not used, instead, an aqueous work-up was performed. GC analysis of a sample of the slurry product (diluted into acetonitrile then filtered to remove inorganic solids, analysis normalized to remove acetonitrile and epi) at the end of the reaction revealed the presence of 0.17 area % unreacted CHDM, 3.2 area % CHDM MGE (0.8 area %, 0.5 area %, 1.3 area %, and 0.6 area % for the 4 individual isomers), 87.6 area % CHDM DGE (23.3 area %, 30.5 area %, 9.9 area %, and 23.9 area % for the 4 individual isomers), 4.8 area % DGE, 1.5 area % oligomers (6 minor components), with the balance as several minor components. After cooling to 25° C., the slurry from the reactor was divided between a pair of 4 L beakers, each filled with ice to the 2 L mark followed by 1 L of water magnetically stirred. Stirring resulted in a suspension of light yellow colored, opaque, liquid suspended in water. The entire suspension from the pair of beakers was diluted in portions into a total of 8 L of dichloromethane. A separatory funnel was used to resolve the clear dichloromethane layer from the aqueous layer which behaved as a gelatinous semi-solid. Rotary evaporation of the dichloromethane yielded 336.4 g of light yellow colored, slightly hazy, liquid. GC analysis revealed the presence of 1.0 area % unreacted CHDM, 4.4 area % CHDM MGE (1.1 area %, 0.6 area %, 1.8 area %, and 0.9 area % for the 4 individual isomers), 88.6 area % CHDM DGE (20.8 area %, 32.5 area %, 10.7 area %, and 24.6 area % for the 4 individual isomers), 4.0 area % DGE, 1.0 area % oligomers (2 minor components), with the balance as several minor components.

### Example 7

### Epoxidation of CHDM Using a Shortened Reaction Time

The epoxidation of CHDM was repeated using the method of Example 5 with a shortened reaction time and no epi addition during postreaction for viscosity reduction (viscosity did not build-up sufficiently to necessitate postreaction addition of epi). GC analysis of a sample of the slurry product (diluted into acetonitrile then filtered to remove inorganic solids, analysis normalized to remove acetonitrile and epi) 18.8 hr from completion of the addition of the CHDM revealed the presence of 0.22 area % unreacted CHDM, 7.07 area % CHDM MGE (2.36 area %, 1.49 area %, 2.06 area %, and 1.16 area % for the 4 individual isomers), 88.58 area % CHDM DGE (23.56 area %, 31.59 area %, 9.90 area %, and 23.53 area % for the 4 individual isomers), 1.07 area % DGE, 1.7 area % oligomers (11 minor components), with the balance as several minor components. At this time, the product slurry was diluted with dichloromethane. The dichloromethane slurry was removed from the reactor and rotary evaporated using a maximum bath temperature of 70° C. to provide a tacky solid product (824.0 g). Rotary evaporation of the filtrate from the extractions with MIBK yielded a cumulative 265.0 g of light yellow colored, transparent liquid. The product from the rotary evaporation was vacuum distilled using the equipment and method of Example 3. The first distillate was collected into the receiver at a pot temperature/overhead temperature/vacuum of 123° C./53° C./1.1 mm Hg. The maximum distillation temperatures reached a 172° C. pot temperature and 146° C. overhead temperature under a vacuum of 0.73 mm Hg and the distillation was stopped at this time. The yellow colored product remaining in the pot comprised 233.69 g. GC analysis of the product in the pot revealed 3.4 area % CHDM MGE (1.02 area %, 0.60 area %, 1.12 area %, and 0.66 area % for the 4 individual isomers), 93.62 area % CHDM DGE (24.16 area %, 33.49 area %, 10.52 area %, and 25.45 area % for the 4 individual isomers), 2.1 area % oligomers (>25 minor components), with the balance as several minor impurities. Titration of an aliquot of the product obtained from the distillation demonstrated 30.37% epoxide (141.71 EEW). Viscosity of an aliquot of the distillation pot product at 25° C. was determined on an I.C.I. Cone and Plate Viscometer. The 4 individual measurements gave viscosities of 85 cp, 86.25 cp, 85 cp, and 86.25 cp for an average of 86 cp. A portion of the product was analyzed for ionic, hydrolyzable and total chlorides giving the following results: Hydrolyzable Cl=112 ppm, Ionic Cl=13.9 ppm, Total Cl=0.146%. A portion of the product obtained from the distillation pot was analyzed by GPC giving the following results: Mₙ=247, M_{w}=364, M_{w}/Mₙ=1.47, Mₚ=197, M_{z}=754, M_{z+1}=1602. Integration of peak windows of the respective peaks gave the following results:

| Peak Window | Mₚ | Area % |
|---|---|---|
| A | 197 | 68.5 |
| B | 323 | 2.8 |
| C | 447 | 14.5 |
| D | 655 | 5.5 |
| E | 834 | 2.8 |
| F | 1000-6500 MW tail | 6.0 |

### Example 8

### Epoxidation of CHDM Using Sodium Hydroxide Pellets at Reduced Sodium Hydroxide Stoichiometry with Decolorization of Epoxy Resin Product from Distillation Pot

A 3 L, 3 neck, glass, round bottom, Morton reactor was charged under nitrogen with epi (1110.2 g, 12.0 moles, 12.0 —OH eq) and sodium hydroxide (pellets, anhydrous, reagent grade, ≧98%) (528.0 g, 13.2 moles, 13.2 eq). The reactor was additionally equipped with a condenser (maintained at −3° C.), a thermometer, a Claisen adaptor, an overhead nitrogen inlet (1 LPM N₂ used), and a stirrer assembly (teflon paddle, glass shaft, variable speed motor). A mixture of pre-warmed CHDM (432.63 g, 3.0 moles, 6.0 —OH eq) was added to a side arm vented addition funnel, then attached to the reactor. Stirring commenced to give a 24° C. slurry of sodium hydroxide in epi concurrent with heating using a thermostatically controlled heating mantle. Once the stirred slurry equilibrated at 40° C., an initial aliquot of CHDM (30.9 g) was added to the reactor. The remaining 13 aliquots (30.9 g) were added at 20 min intervals after addition of the initial aliquot. The reaction temperature was maintained at 40° C. during the addition of the CHDM aliquots. Two hr after completion of the CHDM addition, GC analysis (epi peak normalized out) demonstrated 19.4 area % unreacted CHDM, 55.0 area % CHDM MGE, 23.4 area % CHDM DGE and 0.65 area % oligomers. DGE coproduct was 1.2 area %. After a cumulative 18 hr of reaction, GC analysis (epi peak normalized out) demonstrated no unreacted CHDM, 6.7 area % CHDM MGE, 86.6 area % CHDM DGE and 3.5 area % oligomers. DGE coproduct was 1.6 area %. At this time, the white product slurry had thickened so as to impair mixing. Twenty eight min later, the product slurry was diluted with dichloromethane (800 mL) to facilitate removal from the reactor. The dichloromethane slurry was allowed to stand once cooled to 25° C. and the cloudy liquid layer which formed on top of the solids which had settled out was decanted through a pad of diatomaceous earth supported on a 2 L coarse fritted glass funnel. Salts collecting on top of the pad of diatomaceous earth and occluding filtration were periodically scraped off using a spatula to speed the vacuum filtration. Rotary evaporation of the filtrate provided 521.28 g of light yellow colored, slightly hazy liquid. The solids remaining after decantation plus the fines collected on top of the diatomaceous earth were slurried with fresh toluene (800 mL), then placed on the shaker for the next 16 hr. After mixing ceased, the cloudy liquid layer which formed on top of the solids which had settled out was decanted through the pad of diatomaceous earth. Salts collecting on top of the pad of diatomaceous earth and occluding filtration were again periodically scraped off using a spatula to speed the vacuum filtration. Rotary evaporation of the additional filtrate provided a cumulative 658.36 g of light yellow colored, slightly hazy liquid. A third repetition of slurrying with fresh dichloromethane (800 mL), mixing for 90 min then decantation of the clear liquid top layer through the diatomaceous earth filter provided a cumulative 731.30 g of light yellow colored, hazy liquid after rotary evaporation. A fourth repetition of slurrying with fresh dichloromethane (800 ml), mixing for 60 min then decantation of the clear liquid top layer through the diatomaceous earth filter provided a cumulative 762.94 g of light yellow colored, hazy liquid after rotary evaporation. A fifth repetition of slurrying with fresh dichloromethane (800 ml), mixing for 60 min then decantation of the clear liquid top layer through the diatomaceous earth filter provided a cumulative 764.05 g of light yellow colored, hazy liquid after rotary evaporation. GC analysis revealed the presence of 1.3 area % CHDM MGE, 96.4 area % CHDM DGE, 1.2 area % oligomers, with the balance as several minor components.

The product from the rotary evaporation, plus an additional 636.65 g of product from a duplicate of the aforementioned synthesis and process, was vacuum distilled using the equipment and method of Example 3 with the single exception that the distillation pot size was increased to 2 L. The first distillate was collected into the receiver at a pot temperature/overhead temperature/vacuum of 139° C./60° C./0.90 mmHg. The maximum distillation temperatures reached a 179° C. pot temperature and 151° C. overhead temperature under a vacuum of 0.83 mm Hg and the distillation was stopped at this time. The transparent distillate comprised 71.29 g. The yellow colored product remaining in the pot comprised 1322.07 g.

GC analysis of the product in the distillation pot revealed 95.8 area % CHDM DGE (24.39 area %, 32.61 area %, 12.42 area %, and 26.38 area % for the 4 individual isomers), 3.7 area % oligomers (>46 minor components), with the balance as several minor impurities. Once the product in the distillation pot had cooled to 100° C., activated carbon powder (−100 mesh, Darco® G-60) was added and cooling to room temperature was continued along with magnetic stirring. After 16 hr the product was vacuum filtered through a bed of diatomaceous earth packed on a 2 L fine fritted glass funnel to provide a pale yellow colored liquid. Titration of an aliquot of the product obtained from the filtration demonstrated 27.74% epoxide (155.13 EEW). Viscosity of an aliquot of the product at 25° C. was determined on an I.C.I. Cone and Plate Viscometer. The 3 individual measurements gave viscosities of 86.25 cp, 86.25 cp, and 86.25 cp for an average of 86 cp.

### Comparative Example A

### Characterization of Commercial Grade cis,trans-1,4-Cyclohexanedimethanol diglycidyl ether

A commercial grade of “technical grade” cis,trans-1,4-cyclohexanedimethanol diglycidyl ether obtained from Aldrich Chemical Company (batch #22009TC) was analyzed by GC revealing 1.6 area % cis,trans-1,4-cyclohexanedimethanol (0.3 area % and 1.3 area % for the 2 individual isomers), 7.8 area % cis,trans-1,4-cyclohexanedimethanol monoglycidyl ether (4.7 area % and 3.1 area % for the 2 individual isomers), 61.2 area % cis,trans-1,4-cyclohexanedimethanol diglycidyl ether (19.1 area % and 42.1 area % for the 2 individual isomers), 29.2 area % oligomers (0.63 area %, 1.35 area %, 1.44 area %, 0.68 area %, 7.20 area %, 17.30 area %, 0.22 area %, 0.21 area %, and 0.20 area % for the 9 individual components), with the 0.2 area % balance as a single minor impurity. GC analysis furnished with the product by Aldrich Chemical reported a 56.7% mixture of cis and trans-1,4-isomers. Titration of an aliquot of the product demonstrated 27.05% epoxide (159.05 EEW). The EEW furnished with the product by Aldrich Chemical was 159. Viscosity of an aliquot of the product at 25° C. was determined on an I.C.I. Cone and Plate Viscometer. The 2 individual measurements each gave viscosities of 67.5 cp and 71.25 cp for an average of 69 cp. The viscosity furnished with the product by Aldrich Chemical was 71 cp at 25° C. A portion of the product was analyzed for ionic, hydrolyzable and total chlorides giving the following results: Hydrolyzable Cl=536 ppm, Ionic Cl=21.58 and 21.62 ppm for an average of 21.60 ppm, Total Cl=2.356%. GPC analysis provided the following results: Mₙ=245, M_{w}=265, M_{w}/Mₙ=1.08, Mₚ=205, M_{z}=292, M_{z+1}=331. Integration of peak windows of the respective peaks gave the following results:

| Peak Window | Mₚ | Area % |
|---|---|---|
| A | 205 | 56.1 |
| B | 308 | 33.9 |
| C | 401 | 8.5 |
| D | 400-1000 MW tail | 2.0 |

### Example 9

### Epoxidation Using -40 to +60 Mesh Sodium Hydroxide Powder

A. Preparation and Characterization of −40 to +60 Mesh Sodium Hydroxide Powder

Sodium hydroxide beads (20-40 mesh, 97%) were ground in a dry nitrogen glovebox using a ceramic mortar and pestle. The resultant ground powder was screened on a series of brass wire mesh sieves and the fraction of powder passing thorough the 40 mesh screen but retained on the 60 mesh screen was recovered. Analysis of the 3 sodium hydroxide samples revealed the presence of 2085, 1889 and 2853 ppm water for an average of 2276 ppm. A total of 120.0 g of the −40 to +60 mesh sodium hydroxide powder was sealed in a polyethylene bottle for use in the epoxidation.

B. Epoxidation Using a 1:2:3 Equivalent Ratio of CHDM:Epi:−40 to +60 Mesh Sodium Hydroxide and 40° C. Reaction Temperature

A 1 L, 3 neck, glass, round bottom, Morton reactor was charged under nitrogen with epi (185.04 g, 2.0 moles, 2.0 eq) and −40 to +60 mesh sodium hydroxide (120.0 g, 3.0 moles, 3.0 —OH eq) from A. above. The epi used was analyzed in duplicate with an average of 140 ppm water titrated. The reactor was additionally equipped with a condenser (maintained at −3° C.), a thermometer, a Claisen adaptor, an overhead nitrogen inlet (1 LPM N₂ used), and a stirrer assembly (teflon paddle, glass shaft, variable speed motor). A mixture of pre-warmed CHDM (72.11 g, 0.50 moles, 1.00 —OH eq) was added to a side arm vented addition funnel, then attached to the reactor. Stirring commenced to give a 23° C. slurry of sodium hydroxide in epi concurrent with heating using a thermostatically controlled heating mantle. Once the stirred slurry equilibrated at 40° C., an initial aliquot of CHDM (10.3 g) was added to the reactor. Second, third, fourth, fifth and seventh aliquots (10.3 g) were added at 20 min intervals after addition of the initial aliquot. The sixth aliquot was added 25 min after the fifth aliquot. Immediately before the addition of the fourth aliquot, a sample (60 min) was taken for GC analysis. The reaction temperature was maintained at 40° C. during the addition of the CHDM aliquots. The following samples were taken at the indicated intervals and analyzed via GC:

| COMPONENT | | | | | | |
|---|---|---|---|---|---|---|
| (area %) | 60 min. | 155 min. | 395 min. | 1410 min. | 1585 min. | 1843 min. |
| DGE | none | none | none | 0.54 | 0.63 | 0.50 |
| CHDM | 96.05 | 88.04 | 59.33 | 5.15 | 1.24 | 0.92 |
| CHDM MGE | 2.66 | 10.09 | 35.33 | 16.74 | 12.74 | 9.71 |
| CHDM DGE | 0.08 | 0.35 | 3.85 | 74.93 | 80.77 | 84.50 |
| Oligomers | 0.32 | 0.36 | 0.25 | 1.33 | 3.13 | 2.45 |

C. Work-up and Isolation of Crude Epoxidation Product from Rotary Evaporation

After the final sample (1843 min), the thin, easily stirred product slurry was diluted with toluene (200 mL) to facilitate removal from the reactor. The toluene slurry was removed from the reactor and rotary evaporated using a maximum bath temperature of 70° C. to provide a tacky solid product (276.6 g). The product from the rotary evaporation was slurried with toluene (334 mL) and vigorously mixed by placing on a shaker for 1 hr. After mixing ceased, the clear liquid layer which formed on top of the solids which had settled out was decanted through a pad of diatomaceous earth supported on a 600 mL coarse fritted glass funnel. Salts collecting on top of the pad of diatomaceous earth and occluding filtration were periodically scraped off using a spatula to speed the vacuum filtration. The solids remaining after decantation plus the fines collected on top of the diatomaceous earth were slurried with fresh toluene (334 mL), then placed on the shaker for the next 16 hr. After mixing ceased, the clear liquid layer which formed on top of the solids which had settled out was decanted through the pad of diatomaceous earth. Salts collecting on top of the pad of diatomaceous earth and occluding filtration were again periodically scraped off using a spatula to speed the vacuum filtration. Rotary evaporation of the combined filtrate provided 94.22 g of pale yellow colored, transparent liquid. A third repetition of slurrying with fresh toluene (334 mL), mixing for 30 min then decantation of the clear liquid top layer through the diatomaceous earth filter provided a cumulative 103.65 g of pale yellow colored, transparent liquid after rotary evaporation. A fourth repetition of slurrying with fresh toluene (334 ml), mixing for 90 min then decantation of the clear liquid top layer through the diatomaceous earth filter provided a cumulative 104.21 g of pale yellow colored, transparent liquid after rotary evaporation. It was unnecessary to scrape salts off of the top of the diatomaceous earth pad during the third and fourth filtrations. GC analysis revealed the presence of 0.36 area % unreacted CHDM, 5.62 area % CHDM MGE, 90.72 area % CHDM DGE, 2.03 area % oligomers, with the balance as several minor components.

D. Characterization of Crude Epoxidation Product

Titration of an aliquot of the crude epoxidation product (“crude” designates that the product has not been fully processed to give a final epoxy resin product, e.g. some volatiles have not been removed) obtained from the rotary evaporation demonstrated 28.84% epoxide (149.19 EEW). Viscosity of an aliquot of the product from the distillation pot at 25° C. was determined on an I.C.I. Cone and Plate Viscometer. The 4 individual measurements gave viscosities of 153.75 cp, 151.25 cp, 150 cp, and 151.25 cp for an average of 152 cp. An aliquot of the crude product obtained from the rotary evaporation in Part C above was analyzed for ionic, hydrolyzable and total chlorides giving the following results: Hydrolyzable Cl=42 ppm, Ionic Cl=23.9 ppm, Total Cl=0.131%. A portion of the crude product obtained from the rotary evaporation in C. above was analyzed by GPC giving the following results: Mₙ=269, M_{w}=741, M_{w}/Mₙ=2.76, Mₚ=192, M_{z}=5331, M_{z+1}=17040. Integration of peak windows of the respective peaks gave the following results:

| Peak Window | Mₚ | Area % |
|---|---|---|
| A | 192 | 60.8 |
| B | 314 | 1.3 |
| C | 437 | 13.4 |
| D | 643 | 5.6 |
| E | 823 | 3.4 |
| F | 900-26000 MW tail | 15.8 |
| G | >26000 | 0.1 |

### Example 10

### Epoxidation Using −60 to +80 Mesh Sodium Hydroxide Powder

A. Preparation and Characterization of −60 to +80 Mesh Sodium Hydroxide Powder

Sodium hydroxide beads (20-40 mesh, 97%) were ground in a dry nitrogen glovebox using a ceramic mortar and pestle. The resultant ground powder was screened on a series of brass wire mesh sieves and the fraction of powder passing thorough the 60 mesh screen but retained on the 80 mesh screen was recovered. Analysis of the 3 sodium hydroxide samples revealed the presence of 998, 984 and 1094 ppm water for an average of 1025 ppm. A total of 120.0 g of the −60 to +80 mesh sodium hydroxide powder was sealed in a polyethylene bottle for use in the epoxidation.

B. Epoxidation Using a 1:2:3 Equivalent Ratio of CHDM:Epi:−60 to +80 Mesh Sodium Hydroxide and 40° C. Reaction Temperature

The epoxidation was completed using the method of Example 9 Part B. and the −60 to +80 mesh sodium hydroxide from Part A. above with the single exception that the interval between additions of all CHDM aliquots was 20 min. The following samples were taken at the indicated intervals and analyzed via GC:

| COMPONENT | | | | | | | |
|---|---|---|---|---|---|---|---|
| (area %) | 60 min. | 150 min. | 270 min. | 365 min. | 1367 min. | 1602 min. | 1805 min. |
| DGE | none | none | none | none | 0.73 | 0.85 | 1.13 |
| CHDM | 93.68 | 86.15 | 67.37 | 53.00 | 3.81 | 1.94 | — |
| CHDM MGE | 4.07 | 11.24 | 28.66 | 39.70 | 8.21 | 6.00 | 4.56 |
| CHDM DGE | 0.30 | 0.55 | 2.33 | 5.05 | 84.48 | 87.58 | 87.63 |
| Oligomers | 0.27 | 0.71 | 0.33 | 0.69 | 1.46 | 1.97 | 1.41 |

C. Work-up and Isolation of Crude Epoxidation Product from Rotary Evaporation

After the final sample (1805 min), the thick but still stirred, product slurry was diluted with toluene (200 mL) to facilitate removal from the reactor. The toluene slurry was removed from the reactor and rotary evaporated using a maximum bath temperature of 70° C. to provide a tacky solid product (266.1 g). The product from the rotary evaporation was slurried with toluene (334 mL), then vigorously mixed by placing on a shaker for 16 hr. After mixing ceased, the clear liquid layer which formed on top of the solids which had settled out was decanted through a pad of diatomaceous earth supported on a 600 mL coarse fritted glass funnel. Salts collecting on top of the pad of diatomaceous earth and occluding filtration were periodically scraped off using a spatula to speed the vacuum filtration. Rotary evaporation of the filtrate provided 88.89 g of light yellow, hazy liquid. The solids remaining after decantation plus the fines collected on top of the diatomaceous earth were slurried with fresh toluene (334 mL), then placed on the shaker for the next hr. After mixing ceased, the clear liquid layer which formed on top of the solids which had settled out was decanted through the pad of diatomaceous earth. Rotary evaporation of the filtrate provided a cumulative 96.90 g of light yellow colored, hazy liquid. A third repetition of slurrying with fresh toluene (334 mL), mixing for 30 min then decantation of the clear liquid top layer through the diatomaceous earth filter provided a cumulative 102.62 g of light yellow colored, hazy liquid after rotary evaporation. A fourth repetition of slurrying with fresh toluene (334 mL), mixing for 30 min then decantation of the clear liquid top layer through the diatomaceous earth filter provided a cumulative 106.51 g of light yellow colored, hazy liquid after rotary evaporation. It was unnecessary to scrape salts off of the top of the diatomaceous earth pad during the second, third and fourth filtrations. GC analysis revealed the presence of 1.07 area % unreacted CHDM, 3.37 area % CHDM MGE, 93.26 area % CHDM DGE, 1.18 area % oligomers, with the balance as several minor components.

D. Characterization of Crude Epoxidation Product

Titration of an aliquot of the crude product obtained from the rotary evaporation in Part C. above demonstrated 27.47% epoxide (156.62 EEW). Viscosity of an aliquot of the product at 25° C. was determined on an I.C.I. Cone and Plate Viscometer. The 3 individual measurements gave viscosities of 236.25 cp, 235 cp, and 236.25 cp for an average of 236 cp. An aliquot of the crude product obtained from the rotary evaporation in Part C above was analyzed for ionic, hydrolyzable and total chlorides giving the following results: Hydrolyzable Cl=1377 ppm, Ionic Cl=1394.1 ppm, Total Cl=0.3058%. A portion of the crude product obtained from the rotary evaporation in Part C above was analyzed by GPC giving the following results: Mₙ=292, M_{w}=1189, M_{w}/Mₙ=4.07, Mₚ=195, M_{z}=9849, M_{z+1}=21616. Integration of peak windows of the respective peaks gave the following results:

| Peak Window | Mₚ | Area % |
|---|---|---|
| A | 195 | 55.8 |
| B | 314 | 0.8 |
| C | 443 | 13.3 |
| D | 648 | 5.9 |
| E | 829 | 3.5 |
| F | 900-26000 MW tail | 20.4 |
| G | >26000 | 0.6 |

### Example 11

### Epoxidation Using −80 Mesh Sodium Hydroxide Powder

A. Preparation and Characterization of −80 Mesh Sodium Hydroxide Powder

Sodium hydroxide beads (20-40 mesh, 97%) were ground in a dry nitrogen glovebox using a ceramic mortar and pestle. The resultant ground powder was screened on a brass wire mesh sieve and the fraction of powder passing thorough the 80 mesh screen was recovered. Analysis of the 3 sodium hydroxide samples revealed the presence of 3757 ppm, 3748 ppm and 3252 ppm water for an average of 3586 ppm. A total of 120.0 g of the −80 mesh sodium hydroxide powder was sealed in a polyethylene bottle for use in the epoxidation.

B. Epoxidation Using a 1:2:3 Equivalent Ratio of CHDM:Epi:−80 Mesh Sodium Hydroxide and 40° C. Reaction Temperature

The epoxidation was completed using the method of Example 9 Part B and the −80 mesh sodium hydroxide from Part A above with the single exception that the interval between additions of all CHDM aliquots was 20 min. The following additional samples were taken at the indicated intervals and analyzed via GC:

| COMPONENT | | | | | | |
|---|---|---|---|---|---|---|
| (area %) | 60 min. | 150 min. | 270 min. | 390 min. | 1384 min. | 1722 min. |
| DGE | none | none | 0.27 | 1.18 | 2.89 | 3.35 |
| CHDM | 84.77 | 70.31 | 47.33 | 24.89 | 4.52 | 3.15 |
| CHDM MGE | 12.09 | 21.95 | 21.71 | 15.56 | 5.69 | 6.11 |
| CHDM DGE | 0.70 | 5.51 | 28.55 | 55.27 | 82.69 | 81.85 |
| oligomers | 0.59 | 0.44 | 0.43 | 1.46 | 2.39 | 2.56 |

C. Work-up and Isolation of Crude Epoxidation Product from Rotary Evaporation

After the final sample (1722 min), the thick but still stirred, product slurry was diluted with toluene (200 mL) to facilitate removal from the reactor. The toluene slurry was removed from the reactor and rotary evaporated using a maximum bath temperature of 70° C. to provide a tacky solid product (289.4 g). The product from the rotary evaporation was slurried with toluene (334 mL), then vigorously mixed by placing on a shaker for 16 hr. After mixing ceased, the hazy liquid layer which formed on top of the solids which had settled out was decanted through a pad of diatomaceous earth supported on a 600 mL coarse fritted glass funnel. Salts collecting on top of the pad of diatomaceous earth and occluding filtration were periodically scraped off using a spatula to speed the vacuum filtration. The solids remaining after decantation plus the fines collected on top of the diatomaceous earth were slurried with fresh toluene (334 mL), then placed on the shaker for the next 30 min. After mixing ceased, the hazy liquid layer which formed on top of the solids which had settled out was decanted through the pad of diatomaceous earth. A third repetition of slurrying with fresh toluene (334 mL), mixing for 30 min, then decantation of the clear liquid top layer through the diatomaceous earth filter provided 92.40 g of light yellow colored, hazy liquid after rotary evaporation of the combined filtrate. Salts collecting on top of the pad of diatomaceous earth and occluding filtration were periodically scraped off using a spatula to speed the vacuum filtration. A fourth repetition of slurrying with fresh toluene (334 mL), mixing for 16 hr then decantation of the hazy liquid top layer through the diatomaceous earth filter provided a cumulative 97.39 g of light yellow colored, hazy liquid after rotary evaporation. Salts collecting on top of the pad of diatomaceous earth and occluding filtration were periodically scraped off using a spatula to speed the vacuum filtration. A fifth repetition of slurrying with fresh toluene (334 mL), mixing for 16 hr then decantation of the hazy liquid top layer through the diatomaceous earth filter provided a cumulative 99.06 g of light yellow colored, hazy liquid after rotary evaporation. Salts collecting on top of the pad of diatomaceous earth and occluding filtration were periodically scraped off using a spatula to speed the vacuum filtration. GC analysis revealed the presence of 0.48 area % unreacted CHDM, 3.35 area % CHDM MGE, 90.16 area CHDM DGE, 4.26 area % oligomers, with the balance as several minor components.

D. Characterization of Crude Epoxidation Product

Titration of an aliquot of the crude product obtained from the rotary evaporation in Part C above demonstrated 29.24% epoxide (147.17 EEW). Viscosity of an aliquot of the product at 25° C. was determined on an I.C.I. Cone and Plate Viscometer. The 3 individual measurements gave viscosities of 111.25 cp, 111.25 cp, and 112.50 cp for an average of 112 cp. An aliquot of the crude product obtained from the rotary evaporation in C. above was analyzed for hydrolyzable and total chlorides giving the following results: Hydrolyzable Cl=921 ppm, Ionic Cl=not determined, Total Cl=0.3800%. A portion of the crude product obtained from the rotary evaporation in Part C above was analyzed by GPC giving the following results: Mₙ=262, M_{w}=509, M_{w}/Mₙ=1.94, Mₚ=197, M_{z}=2459, M_{z+1}=10051. Integration of peak windows of the respective peaks gave the following results:

| Peak Window | Mₚ | Area % |
|---|---|---|
| A | 197 | 63.6 |
| B | 448 | 16.4 |
| C | 658 | 6.4 |
| D | 850 | 3.5 |
| E | 900-26000 MW tail | 10.4 |

### Example 12

### Epoxidation CHDM Using Aqueous Sodium Hydroxide with Continuous Vacuum Distillation of Epichlorohydrin-Water Azeotrope

A 3 L, 5 neck, glass, round bottom, Morton reactor was charged under nitrogen with epi (555.12 g, 6.0 moles) and CHDM (216.32 g, 1.50 moles, 3.0 —OH eq). The reactor was additionally equipped with a water separator filled with epi (225 mL) topped by a condenser (maintained at −3° C.) which was capped with a vacuum takeoff, a thermometer, a ground glass stopper, and a stirrer assembly (teflon paddle, glass shaft, variable speed motor). The vacuum system included an in-line thermal conductivity vacuum gauge, vacuum pump, needle valve for regulation of the vacuum and a liquid nitrogen trap. A sodium hydroxide solution prepared by dissolving sodium hydroxide (156.0 g, 3.9 moles) into DI water (156.0 g) was added to a side arm vented addition funnel then attached to the reactor. Stirring commenced to give a 22° C. cloudy mixture of CHDM in epi concurrent with heating using a thermostatically controlled heating mantle. A clear solution formed at 31° C. Once the stirred solution reached 61° C., vacuum was applied to the system and at 1.5 mm Hg, strong distillation of epi into the water separator was established with concurrent recycle of epi back into the reactor. Once the system equilibrated at 61° C. and >2 mm Hg, dropwise addition of aqueous sodium hydroxide commenced. After 3 min, the first drop of water was noted in the water separator. After a cumulative 35 min, the reaction temperature was 64° C. under a vacuum of 1.9 mm Hg with 15 mL of water observed in the water separator and the reaction had become an easily stirred thin slurry. Addition of the aqueous sodium hydroxide was completed after a cumulative 238 min. The reaction was held under vacuum at 62-63° C. for an additional 32 min (270 min cumulative), then the heating mantle was temporarily removed and the reactor was cooled to 40° C. over the next 8 min (278 min cumulative). At this time, the cumulative water removed via the water separator was 210 mL. At this time a sample was also taken for GC analysis. After holding the reaction product at under vacuum at 40° C. for an additional 40 min (318 min cumulative) the vacuum was shut off, the condenser was opened to vent and a nitrogen inlet (1 LPM N₂ used) was installed on the reactor in place of the ground glass stopper. The reaction temperature was maintained at 40° C. for the next 14.6 hr (19.9 hr cumulative) and an additional sample was taken for GC analysis at this time. The product was an off-white, thin slurry. The following results were obtained for the GC analyses:

| COMPONENT (area %) | 278 min | 19.9 hr |
|---|---|---|
| DGE | 0.99 | 1.07 |
| CHDM | 0.68 | 0.03 |
| CHDM MGE | 26.59 | 22.05 |
| CHDM DGE | 67.95 | 72.53 |
| Oligomers | 1.67 | 1.92 |

### Example 13

### Epoxidation CHDM Using Increased Aqueous Sodium Hydroxide Stoichiometry with Continuous Vacuum Distillation of Epichlorohydrin-Water Azeotrope

The epoxidation of Example 12 was repeated using a sodium hydroxide solution prepared by dissolving sodium hydroxide (240.0 g, 6.0 moles) into DI water (240.0 g). Once the stirred solution reached 65° C., vacuum was applied to the system and at 2.0 mm Hg, strong distillation of epi into the water separator was established with concurrent recycle of epi back into the reactor and dropwise addition of aqueous sodium hydroxide commenced. After 8 min, the first drop of water was noted in the water separator. Addition of the aqueous sodium hydroxide was completed after a cumulative 221 min. The reaction was held under vacuum at 60-63° C. for an additional 139 min (360 min cumulative) and a sample was taken for GC analysis. After an additional 51 min (411 min cumulative) under vacuum at 63° C., the heating mantle was temporarily removed and the reactor was cooled to 40° C. over the next 17 min (428 min cumulative), the vacuum was shut off, the condenser was opened to vent and a nitrogen inlet (1 LPM N₂ used) was installed on the reactor in place of the ground glass stopper. At this time, the cumulative water removed via the water separator was 300 mL. The reaction temperature was maintained at 40° C. for the next 15.3 hr (22.4 hr cumulative) and an additional sample was taken for GC analysis at this time. The product was an off-white, thin slurry. The following results were obtained for the GC analyses:

| COMPONENT (area %) | 360 min | 22.4 hr |
|---|---|---|
| DGE | 1.16 | 1.39 |
| CHDM | none | none |
| CHDM MGE | 19.27 | 20.11 |
| CHDM DGE | 74.44 | 73.38 |
| Oligomers | 2.51 | 2.69 |

After cooling to 25° C. the product slurry was diluted with dichloromethane (800 mL). The dichloromethane slurry was equally divided into 6 high density polyethylene bottles which were sealed and centrifuged at 3000 RPM for 1 hr. The top layer of clear liquid was decanted through a 1.5 inch pad of diatomaceous earth supported on a 600 mL coarse fritted glass funnel using vacuum. The bed of diatomaceous earth was prepared by packing 0.5 inch of Celite® 545, followed by 0.5 inch of Celite® standard Super-Cel, then 0.5 inch of Celite® 545. The solids remaining in the bottles were equally diluted using fresh dichloromethane (each bottle was filled to 350.0 g total wt), then placed on the mechanical shaker for 1 hr, followed by centrifuging and decantation, as previously described. Additional dichloromethane (100 mL) was used to wash the product remaining in the contents of the filter into the filtrate. The combined filtrate was a transparent, light yellow colored solution. Rotary evaporation of the filtrate using a maximum oil bath temperature of 70° C. provided 339.46 g of transparent, light yellow colored liquid. A further extraction, centrifuging, decantation and rotary evaporation using the previously described methods provided 25.19 g additional product. Titration of an aliquot of the crude product obtained from the rotary evaporation demonstrated 29.11% epoxide (147.84 EEW). An additional sample of the product was analyzed by GC. Additional rotary evaporation of the filtrate finishing with a maximum oil bath temperature of 140° C. for 1 hr provided 347.05 g of transparent, light yellow liquid. Titration of an aliquot of the crude product obtained from the rotary evaporation finished at 140° C. demonstrated 28.34% epoxide (151.86 EEW). A sample of the product was analyzed by GC, giving the following results:

Rotary Evaporation Temperature

| COMPONENT (area %) | 70° C. | 140° C. |
|---|---|---|
| DGE | 0.75 | none |
| CHDM | none | none |
| CHDM MGE | 18.72 | 19.4 |
| CHDM DGE | 75.88 | 77.0 |
| Oligomers | 2.55 | 3.3 |

Viscosity of an aliquot of the product at 25° C. was determined on an I.C.I. Cone and Plate Viscometer. The 3 individual measurements gave a viscosity of 76.25 cp, 76.25 cp, and 76.25 cp for an average of 76 cp. An aliquot of the crude product obtained from the rotary evaporation was analyzed for ionic, hydrolyzable and total chlorides giving the following results: Hydrolyzable Cl=277 ppm, Ionic Cl=0.39 ppm, Total Cl=0.136%. A portion of the crude product obtained from the rotary evaporation was analyzed by GPC giving the following results: Mₙ=229, M_{w}=286, M_{w}/Mₙ=1.24, Mₚ=200, M_{z}=470, M_{z+1}=980. Integration of peak windows of the respective peaks gave the following results:

| Peak Window | Mₚ | Area % |
|---|---|---|
| A | 200 | 77.9 |
| B | 300 | 3.8 |
| C | 430 | 12.3 |
| D | 630 | 6.4 |

### Example 14

### Lewis Acid Catalyzed Coupling of Epi and CHDM Using Boron Trifluoride Etherate Followed by Epoxidation

A 3 L, 5 neck, glass, round bottom, Morton reactor was charged under nitrogen with CHDM (865.26 g, 6.00 moles, 12.0 —OH eq). The reactor was additionally equipped with a condenser (maintained at 0° C.), a thermometer, a Claisen adaptor, an overhead nitrogen inlet (1 LPM N₂ used), and a stirrer assembly (teflon paddle, glass shaft, variable speed motor). Epi (1313.9 g, 14.2 moles) was added to a side arm vented addition funnel, then attached to the reactor. Stirring commenced concurrent with heating using a thermostatically controlled heating mantle. Once the stirred CHDM reached 52° C., boron trifluoride etherate (1.28 g, 0.0090 mole) was added to the reactor. Once the temperature equilibrated at 50° C. the first aliquot of epi (106.1 g, 8.07 wt % of total epi) was added dropwise over 12 min. The reaction temperature was observed for the next 5 min and controlled to 50° C. by cycling between heating and cooling via a cooling fan on the reactor exterior. Dropwise addition of the remaining epi (1207.8 g) commenced and was completed over 203 min while maintaining the temperature at 50° C. Two hr after completion of the epi addition, an aliquot of the coupling product was analyzed via GC revealing 11.82 area % epi, 3.23 area % CHDM, 25.64 area % CHDM monochlorohydrin, 47.42 area % CHDM dichlorohydrin and 10.77 area % oligomer precursors. After an additional 2.1 hr., GC analysis revealed 0.56 area % epi, 0.39 area % CHDM, 10.83 area % CHDM monochlorohydrin, 59.11 area % CHDM dichlorohydrin and 26.64 area % oligomer precursors. After an additional 1 hr, GC analysis revealed 0.08 area % epi, 0.40 area % CHDM, 11.07 area % CHDM monochlorohydrin, 59.93 area % CHDM dichlorohydrin and 26.35 area % oligomer precursors. At this time, DI water (800 mL) and MIBK (566 g) were added to the stirred reactor.

Heating to 70° C. commenced and dropwise addition of a solution of sodium hydroxide (528 g, 13.2 moles) in DI water (528 g) commenced and was completed over the next 188 min while maintaining the temperature at 70° C. One hr after completion of the aqueous sodium hydroxide addition, an aliquot of the epoxidation product was analyzed via GC revealing 0.31 area % CHDM, 8.86 area % CHDM MGE, 48.49 area % CHDM DGE and 38.48 area % oligomers. An additional hr after completion of the aqueous sodium hydroxide addition, an aliquot of the epoxidation product was analyzed via GC revealing 0.38 area % CHDM, 8.47 area % CHDM MGE, 49.40 area % CHDM DGE and 40.29 area % oligomers. At this time additional DI water (507 mL) was added to the reactor followed by shutting off stirring and pouring the reactor contents into a pair of separatory funnels. The aqueous layer was resolved and discarded to waste. The remaining organic layers were each washed with fresh DI water (400 mL). The recovered organic layer was added back into the reactor followed by reheating to 70° C. and addition of a solution of sodium hydroxide (80 g, 2.0 moles) in DI water (160 g). Two hr after addition of the aqueous sodium hydroxide, stirring was shut off the reactor contents poured into a pair of separatory funnels. The aqueous layer was resolved and discarded to waste. The remaining organic layers were each washed with fresh DI water (400 mL). The recovered organic layer was added back into the reactor followed by a repeat of the aforementioned treatment with aqueous sodium hydroxide. After an additional final wash with fresh DI water (800 mL), rotary evaporation at a 70° C. oil bath temperature to remove the bulk of the volatiles followed by holding at 110° C. and a vacuum of 0.5 mm Hg for 4 hr provided 1713.32 g of colorless liquid. The product was vacuum filtered through a pad of diatomaceous earth packed in a medium fritted glass funnel. GC analysis revealed the presence of 0.16 area % unreacted CHDM, 8.00 area % CHDM MGE, 51.07 area % CHDM DGE, 40.33 area % oligomers, with the balance as several minor components.

Titration of an aliquot of the product demonstrated 25.66% epoxide (167.71 EEW). Viscosity of an aliquot of the product at 25° C. was determined on an I.C.I. Cone and Plate Viscometer using the method given in Example 1 Part C. The 4 individual measurements gave a viscosity of 76.25 cp, 75 cp, 72.5 cp, 77.5 cp and 77.5 cp for an average of 76 cp. An aliquot of the crude product obtained from the rotary evaporation was analyzed for ionic, hydrolyzable and total chlorides giving the following results: Hydrolyzable Cl=79.99 ppm, Ionic Cl=none detected, Total Cl=5.48%.

### Example 15

### Lewis Acid Catalyzed Coupling of Epi and CHDM Using Tin (IV) Chloride Followed by Epoxidation

The coupling and epoxidation reactions of Example 14 were repeated with use of tin (IV) chloride (4.69 g, 0.018 mole) as the Lewis acid catalyst in place of boron trifluoride etherate. One hr after completion of the epi addition, an aliquot of the coupling product was analyzed via GC revealing no detectable epi, a trace (non-integratable) of CHDM, 5.86 area % CHDM monochlorohydrin, 65.48 area % CHDM dichlorohydrin and 28.24 area % oligomer precursors. To complete epoxidation reaction, an additional treatment at 70° C. with a solution of sodium hydroxide (80 g, 2.0 moles) in DI water (160 g) was added to the method of Example 14. The product comprised 1702.18 g of colorless liquid. GC analysis revealed the presence of 0.06 area % unreacted CHDM, 4.19 area % CHDM MGE, 58.73 area % CHDM DGE, 36.79 area % oligomers, with the balance as several minor components. Titration of an aliquot of the product demonstrated 27.42% epoxide (156.93 EEW). Viscosity of an aliquot of the product at 25° C. was determined on an I.C.I. Cone and Plate Viscometer using the method given in Example 1 Part C. The 4 individual measurements gave a viscosity of 66.25 cp, 66.25 cp, 66.25 cp and 65 cp for an average of 66 cp. An aliquot of the crude product obtained from the rotary evaporation was analyzed for ionic, hydrolyzable and total chlorides giving the following results: Hydrolyzable Cl=none detected, Ionic Cl=none detected, Total Cl=3.52%.

It will be obvious to persons skilled in the art that certain changes may be made in the methods described above without departing from the scope of the invention. It is therefore intended that all matter herein disclosed be interpreted as illustrative only and not as limiting the scope of protection sought. Moreover, the process of the present invention is not to be limited by the specific examples set forth above including the tables to which they refer. Rather, these examples and the tables they refer to are illustrative of the process of the invention.

1. An epoxy resin comprising a cis, trans-1,3- and -1,4-cyclohexanedimethylether moiety.

2. The epoxy resin according to claim 1 comprising (i) a diglycidyl ether of cis-1,3-cyclohexanedimethanol, a diglycidyl ether of trans-1,3-cyclohexanedimethanol, a diglycidyl ether of cis-1,4-cyclohexanedimethanol, and a diglycidyl ether of trans-1,4-cyclohexanedimethanol; (ii) a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, and one or more oligomers thereof; (iii) a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, a monoglycidyl ether of cis-1,3-cyclohexanedimethanol, a monoglycidyl ether of trans-1,3-cyclohexanedimethanol, a monoglycidyl ether of cis-1,4-cyclohexanedimethanol, and a monoglycidyl ether of trans-1,4-cyclohexanedimethanol or (iv) a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, a monoglycidyl ether of cis-1,3-cyclohexanedimethanol, a monoglycidyl ether of trans-1,3-cyclohexanedimethanol, a monoglycidyl ether of cis-1,4-cyclohexanedimethanol, a monoglycidyl ether of trans-1,4-cyclohexanedimethanol, and one or more oligomers thereof.

3. The epoxy resin according to claim 2 comprising a controlled amount of the monoglycidyl ether of cis-1,3-cyclohexanedimethanol, monoglycidyl ether of trans-1,3-cyclohexanedimethanol, monoglycidyl ether of cis-1,4-cyclohexanedimethanol, and monoglycidyl ether of trans-1,4-cyclohexanedimethanol; and wherein the amount of the monoglycidyl ether of cis-1,3-cyclohexanedimethanol, monoglycidyl ether of trans-1,3-cyclohexanedimethanol, monoglycidyl ether of cis-1,4-cyclohexanedimethanol, and monoglycidyl ether of trans-1,4-cyclohexanedimethanol is from about 0.1 percent to about 90 percent by weight based on the total weight of the epoxy resin.

4. A process for preparing an epoxy resin comprising reacting (a) a mixture of a cis-1,3-cyclohexanedimethanol, a trans-1,3-cyclohexanedimethanol, a cis-1,4-cyclohexanedimethanol, and a trans-1,4-cyclohexanedimethanol, (b) an epihalohydrin, (c) a basic acting substance, (d) optionally, a solvent, (e) optionally, a catalyst, and/or (f) optionally, a dehydrating agent.

5. The process according to claim 4, wherein the mixture (a) comprises from 1 percent to 99 percent of the cis-1,3-cyclohexanedimethanol and the trans-1,3-cyclohexanedimethanol; and wherein the amount of each of the cis-1,3-cyclohexanedimethanol, trans-1,3-cyclohexanedimethanol, cis-1,4-cyclohexanedimethanol, and trans-1,4-cyclohexanedimethanol in the mixture (a) varies between 5 percent to 95 percent by weight based on the total weight of the mixture.

6. The process according to claim 5, wherein the amount of cis-1,3-cyclohexanedimethanol and the cis-1,4-cyclohexanedimethanol is higher than the amount of trans-1,3-cyclohexanedimethanol and trans-1,4-cyclohexanedimethanol in the mixture (a); or wherein the amount of cis-1,3-cyclohexanedimethanol and the cis-1,4-cyclohexanedimethanol is lower than the amount of trans-1,3-cyclohexanedimethanol and trans-1,4-cyclohexanedimethanol in the mixture (a).

7. The process according to claim 4, wherein the epihalohydrin comprises one of epichlorohydrin, epibromohydrin, epiiodohydrin, methylepichlorohydrin, methylepibromohydrin, methylepiiodohydrin, and any combination thereof; and wherein the ratio of the epihalohydrin to the mixture (a) is from 1:1 to 25:1 equivalents of epihalohydrin per primary hydroxyl group in the mixture (a).

8. The process according to claim 4, wherein a solvent is present in the process; and wherein the solvent comprises at least one of aliphatic hydrocarbon, aromatic hydrocarbon, halogenated aliphatic hydrocarbon, aliphatic ether, aliphatic nitrile, cyclic ether, ketone, amide, sulfoxide, and any combination thereof.

9. The process according to claim 4, wherein a solvent is absent in the process; and wherein the epihalohydrin comprises a mole ratio of from 2:1 to 5:1 moles of equivalents of epihalohydrin per primary hydroxyl group in the mixture (a).

10. The process according to claim 4, further comprising first reacting the mixture (a) with an alkali metal hydride to form an intermediate reaction product and followed by reacting the intermediate reaction product with the epihalohydrin; and wherein the alkali metal hydride is at least one of sodium hydride and potassium hydride.

11. The process according to claim 4, wherein the basic acting substance comprises at least one of the alkali metal hydroxide, alkaline earth metal hydroxide, carbonate, bicarbonate, and any mixture thereof.

12. The process according to claim 4, wherein the process is conducted at a temperature of from 20° C. to 120° C.; wherein the process is conducted at a pressure of from 30 mm Hg vacuum to 100 psia; and wherein the process is completed in about 1 hour to about 120 hours.

13. The process according to claim 4 further comprising recovering and purifying the epoxy resin; wherein the recovering and purifying are conducted by one of the methods of gravity filtration, vacuum filtration, centrifugation, water washing or water extraction, solvent extraction, decantation, column chromatography, vacuum distillation, falling film distillation, wiped film distillation, electrostatic coalescence, and any combination of methods thereof; and wherein the process comprising the recovering and purifying the epoxy resin is a non-aqueous process.

14. The process according to claim 4, wherein the basic acting substance is in the form of a pellet, a bead, or a powder; or wherein the basic acting substance is in an aqueous solution (water); wherein the solvent other than water comprises toluene or xylene; and wherein the process is a slurry epoxidation process.

15. The process according to claim 14 further comprising an additional epihalohydrin back-added to the reaction; and wherein the amount of the additional epihalohydrin back-added is from 0.25 to 2 equivalents of epichlorohydrin per primary hydroxyl group in the mixture (a).

16. The process according to claim 4 wherein the basic acting substance is an aqueous solution (water); and wherein the process is an anhydrous epoxidation process.

17. The process according to claim 14, wherein the water is removed by a distillation method; and wherein the distillation method comprises an azeotropic distillation, a co-distillation, or a flash distillation.

18. The process according to claim 17, wherein the azeotropic distillation comprises (i) adding the basic acting substance in the aqueous solution (water) to the solvent other than water to form a solvent-water azeotrope, and (ii) distilling the solvent-water azeotrope to remove the water from the basic acting substance; or wherein the co-distillation comprises (i) adding the basic acting substance in the aqueous solution (water) to the solvent other than water to form a water solvent co-distillate, and (ii) distilling the water solvent co-distillate to remove the water from the basic acting substance.

19. The process according to claim 17, wherein the azeotropic distillation comprises (i) adding the epihalohydrin to the basic acting substance in the aqueous solution (water) to form a binary epihalohydrin-water azeotrope or adding the epihalohydrin to the basic acting substance in the aqueous solution (water) and the solvent to form a ternary epihalohydrin-water-solvent azeotrope, and (ii) distilling the binary epihalohydrin-water azeotrope or the ternary epihalohydrin-water-solvent azeotrope to remove the water from the basic acting substance; or wherein the co-distillation comprises (i) adding the basic acting substance in the aqueous solution (water) to the solvent to form a water solvent co-distillate, and (ii) distilling the water solvent co-distillate to remove the water from the basic acting substance.

20. The process according to claim 4 comprising (i) reacting, in a coupling reaction, (a) a mixture of a cis-1,3-cyclohexanedimethanol, a trans-1,3-cyclohexanedimethanol, a cis-1,4-cyclohexanedimethanol, and a trans-1,4-cyclohexanedimethanol, (b) an epihalohydrin in the presence of (c) a Lewis acid catalyst to form an intermediate reaction product, and (ii) reacting the intermediate reaction product, in a dehydrohalogenation reaction, with (d) a basic acting substance in an aqueous solution, (e) optionally, a solvent, and/or (f) optionally, a catalyst other than the Lewis acid catalyst.

21. The process according to claim 20, wherein the coupling reaction comprises reacting the mixture (a) with the epihalohydrin in the presence of the Lewis acid catalyst to form a halohydrin intermediate product; and wherein the Lewis acid comprises tin (IV) chloride, boron trifluoride, a boron trifluoride complex, boron trifluoride etherate, aluminum chloride, ferric chloride, zinc chloride, silicon tetrachloride, titanium tetrachloride, antimony trichloride, or any mixture thereof.

22. The process according to claim 21, wherein the dehydrohalogenation reaction comprises reacting the halohydrin intermediate product with the basic acting substance in the aqueous solution to form the epoxy resin.

23. A curable epoxy resin composition comprising a blend of (a) an epoxy resin, (b) at least one curing agent, and/or (c) at least one curing catalyst, wherein the epoxy resin comprises a cis, trans-1,3- and -1,4-cyclohexanedimethylether moiety.

24. The composition according to claim 23 further comprising an additive; and wherein the additive comprises at least one of a cure accelerator, a solvent, a diluent, a filler, a pigment, a dye, a flow modifier, a thickener, a reinforcing material, a mold release agent, a wetting agent, a stabilizer, a fire retardant agent, a surfactant, and any combination thereof.

25. The process of curing the curable epoxy resin composition according to claim 23, wherein the process comprises partially curing the curable epoxy resin composition of claim 23 to form a B-stage product and subsequently curing the B-stage product completely at a later time.

26. A cured epoxy resin prepared by curing the curable epoxy resin composition according to claim 23.

27. An article comprising the cured epoxy resin, of claim 26; wherein the article is at least one of a coating, an electrical or structural laminate, an electrical or structural composite, a filament winding, a molding, a casting, or an encapsulation.
